(19) United States
(12) Patent Application Publication
(10) Pub. No.: US 2023/0105748 A1
(43) Pub. Date: Apr. 6, 2023

(54) DOWNLINK TRANSMIT POWER ADJUSTMENT

(71) Applicant: QUALCOMM Incorporated, San Diego, CA (US)

(72) Inventors: Navid ABEDINI, Basking Ridge, NJ (US); Qian ZHANG, Basking Ridge, NJ (US); Jianghong LUO, Skillman, NJ (US); Tao LUO, San Diego, CA (US)

(21) Appl. No.: 17/935,324

(22) Filed: Sep. 26, 2022

Related U.S. Application Data
(60) Provisional application No. 63/262,019, filed on Oct. 1, 2021.

(51) Int. Cl. H04W 52/32; H04W 56/00

(52) U.S. Cl. CPC H04W 52/325; H04W 56/001

(57) ABSTRACT

This disclosure provides systems, methods, and apparatuses for adjustment of transmit powers for different transmissions of a reference signal. Some techniques and apparatuses described herein provide semi-static configuration or dynamic signaling such that a transmit power of a reference signal such as a synchronization signal block (SSB) or a channel state information reference signal (CSI-RS) can be modified from transmission-to-transmission. Additionally, this disclosure provides modification of a transmit power of a physical downlink shared channel (PDSCH) from transmission-to-transmission, such as using semi-static configuration or dynamic signaling. By modifying transmit power of an SSB, CSI-RS, or PDSCH, a network node may reduce interference and enable full-duplex or enhanced duplex operation. Furthermore, the network node may conserve energy by modifying transmit power. Still further, the techniques described herein may reduce overhead relative to reconfiguring an SSB, a CSI-RS resource, or a PDSCH each time a transmit power is to be modified.

### CROSS-REFERENCE TO RELATED APPLICATION

This Patent Application claims priority to U.S. Provisional Pat. Application No. 63/262,019, filed on Oct. 1, 2021, entitled “DOWNLINK TRANSMIT POWER ADJUSTMENT,” and assigned to the assignee hereof. The disclosure of the prior Application is considered part of and is incorporated by reference into this Patent Application.

### TECHNICAL FIELD

Aspects of the present disclosure relate generally to wireless communication and to techniques for downlink transmit power adjustment.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method of wireless communication performed by an apparatus of a network node. The method may include transmitting a configuration that indicates a first transmit power associated with a first transmission of a downlink reference signal and a second transmit power associated with a second transmission of the downlink reference signal, where the first transmit power is different than the second transmit power. The method may include transmitting the first transmission of the downlink reference signal in accordance with the first transmit power. The method may include transmitting the second transmission of the downlink reference signal in accordance with the second transmit power.

In some implementations, the first transmission and the second transmission are transmissions of a synchronization signal block (SSB) burst set including the downlink reference signal.

In some implementations, the configuration is included in a synchronization signal block measurement timing configuration (SMTC) for a cell or group of cells on which the downlink reference signal is transmitted.

In some implementations, the configuration is included in a synchronization signal block transmission configuration (STC).

Another innovative aspect of the subject matter described in this disclosure can be implemented in an apparatus of a network node for wireless communication. The apparatus may include one or more interfaces configured to output a configuration that indicates a first transmit power associated with a first transmission of a downlink reference signal and a second transmit power associated with a second transmission of the downlink reference signal, where the first transmit power is different than the second transmit power. The one or more interfaces may be configured to output the first transmission of the downlink reference signal in accordance with the first transmit power. The one or more interfaces may be configured to output the second transmission of the downlink reference signal in accordance with the second transmit power.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a network node, may cause the one or more processors to transmit a configuration that indicates a first transmit power associated with a first transmission of a downlink reference signal and a second transmit power associated with a second transmission of the downlink reference signal, where the first transmit power is different than the second transmit power. The one or more instructions, when executed by one or more processors of a network node, may cause the one or more processors to transmit the first transmission of the downlink reference signal in accordance with the first transmit power. The one or more instructions, when executed by one or more processors of a network node, may cause the one or more processors to transmit the second transmission of the downlink reference signal in accordance with the second transmit power.

Another innovative aspect of the subject matter described in this disclosure can be implemented in an apparatus for wireless communication. The apparatus may include means for transmitting a configuration that indicates a first transmit power associated with a first transmission of a downlink reference signal and a second transmit power associated with a second transmission of the downlink reference signal, where the first transmit power is different than the second transmit power. The apparatus may include means for transmitting the first transmission of the downlink reference signal in accordance with the first transmit power. The apparatus may include means for transmitting the second transmission of the downlink reference signal in accordance with the second transmit power.

Another innovative aspect of the subject matter described in this disclosure can be implemented in a method of wireless communication performed by an apparatus of a network node. The method may include transmitting a configuration that indicates a first transmit power associated with a first physical downlink shared channel (PDSCH) and a second transmit power associated with a second PDSCH, where the first transmit power is different than the second transmit power. The method may include transmitting the first PDSCH in accordance with the first transmit power. The method may include transmitting the second PDSCH in accordance with the second transmit power.

In some implementations, the configuration indicates the first transmit power or the second transmit power based at least in part on updating a power control offset parameter of a channel state information reference signal (CSI-RS) configuration, where the power control offset parameter is between a CSI-RS and a synchronization signal or between a CSI-RS and a PDSCH.

In some implementations, the first transmit power is associated with a first power control offset parameter of a CSI-RS configuration and the second transmit power is associated with a second power control offset parameter of the CSI-RS configuration.

In some implementations, the configuration is a downlink bandwidth part configuration.

Another innovative aspect of the subject matter described in this disclosure can be implemented in an apparatus of a network node for wireless communication. The apparatus may include one or more interfaces configured to output a configuration that indicates a first transmit power associated with a first PDSCH and a second transmit power associated with a second PDSCH, where the first transmit power is different than the second transmit power. The one or more interfaces may be configured to output the first PDSCH in accordance with the first transmit power. The one or more interfaces may be configured to output the second PDSCH in accordance with the second transmit power.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a network node, may cause the one or more processors to transmit a configuration that indicates a first transmit power associated with a first PDSCH and a second transmit power associated with a second PDSCH, where the first transmit power is different than the second transmit power. The one or more instructions, when executed by one or more processors, may cause the one or more processors to transmit the first PDSCH in accordance with the first transmit power. The one or more instructions, when executed by one or more processors, may cause the one or more processors to transmit the second PDSCH in accordance with the second transmit power.

Another innovative aspect of the subject matter described in this disclosure can be implemented in an apparatus for wireless communication. The apparatus may include means for transmitting a configuration that indicates a first transmit power associated with a first PDSCH and a second transmit power associated with a second PDSCH, where the first transmit power is different than the second transmit power. The apparatus may include means for transmitting the first PDSCH in accordance with the first transmit power. The apparatus may include means for transmitting the second PDSCH in accordance with the second transmit power.

Another innovative aspect of the subject matter described in this disclosure can be implemented in a method of wireless communication performed by an apparatus of a wireless communication device. The method may include receiving a configuration that indicates a first transmit power associated with a first transmission of a downlink reference signal and a second transmit power associated with a second transmission of the downlink reference signal, where the first transmit power is different than the second transmit power. The method may include receiving the first transmission of the downlink reference signal in accordance with the first transmit power. The method may include receiving the second transmission of the downlink reference signal in accordance with the second transmit power.

In some implementations, the first transmission and the second transmission are transmissions of a synchronization signal block burst set including the downlink reference signal.

In some implementations, receiving the first transmission or receiving the second transmission is based at least in part on at least one of: a configured timeline for applying the configuration, or a timeline, indicated by the configuration, for applying the configuration.

In some implementations, the configuration includes a first synchronization SMTC that indicates the first transmit power and a second SMTC that indicates the second transmit power.

Another innovative aspect of the subject matter described in this disclosure can be implemented in an apparatus of a wireless communication device for wireless communication. The apparatus may include one or more interfaces configured to obtain a configuration that indicates a first transmit power associated with a first transmission of a downlink reference signal and a second transmit power associated with a second transmission of the downlink reference signal, where the first transmit power is different than the second transmit power. The apparatus may include one or more interfaces configured to obtain the first transmission of the downlink reference signal in accordance with the first transmit power. The apparatus may include one or more interfaces configured to obtain the second transmission of the downlink reference signal in accordance with the second transmit power.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a wireless communication device, may cause the one or more processors to receive a configuration that indicates a first transmit power associated with a first transmission of a downlink reference signal and a second transmit power associated with a second transmission of the downlink reference signal, where the first transmit power is different than the second transmit power. The one or more instructions, when executed by one or more processors, may cause the one or more processors to receive the first transmission of the downlink reference signal in accordance with the first transmit power. The one or more instructions, when executed by one or more processors, may cause the one or more processors to receive the second transmission of the downlink reference signal in accordance with the second transmit power.

Another innovative aspect of the subject matter described in this disclosure can be implemented in an apparatus for wireless communication. The apparatus may include means for receiving a configuration that indicates a first transmit power associated with a first transmission of a downlink reference signal and a second transmit power associated with a second transmission of the downlink reference signal, where the first transmit power is different than the second transmit power. The apparatus may include means for receiving the first transmission of the downlink reference signal in accordance with the first transmit power. The apparatus may include means for receiving the second transmission of the downlink reference signal in accordance with the second transmit power.

Another innovative aspect of the subject matter described in this disclosure can be implemented in a method of wireless communication performed by an apparatus of a wireless communication device. The method may include receiving a configuration that indicates a first transmit power associated with a first PDSCH and a second transmit power associated with a second PDSCH, where the first transmit power is different than the second transmit power. The method may include receiving the first PDSCH in accordance with the first transmit power. The method may include receiving the second PDSCH in accordance with the second transmit power.

In some implementations, the configuration indicates the first transmit power or the second transmit power based at least in part on updating a power control offset parameter of a CSI-RS configuration, where the power control offset parameter is between a CSI-RS and a synchronization signal or between a CSI-RS and a PDSCH.

In some implementations, the first transmit power is associated with a first power control offset parameter of a CSI-RS configuration and the second transmit power is associated with a second power control offset parameter of the CSI-RS configuration.

In some implementations, the configuration is a downlink bandwidth part configuration.

Another innovative aspect of the subject matter described in this disclosure can be implemented in an apparatus of a wireless communication device for wireless communication. The apparatus may include one or more interfaces configured to obtain a configuration that indicates a first transmit power associated with a first PDSCH and a second transmit power associated with a second PDSCH, where the first transmit power is different than the second transmit power. The apparatus may include one or more interfaces configured to obtain the first PDSCH in accordance with the first transmit power. The apparatus may include one or more interfaces configured to obtain the second PDSCH in accordance with the second transmit power.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a wireless communication device, may cause the one or more processors to receive a configuration that indicates a first transmit power associated with a first PDSCH and a second transmit power associated with a second PDSCH, where the first transmit power is different than the second transmit power. The one or more instructions, when executed by one or more processors, may cause the one or more processors to receive the first PDSCH in accordance with the first transmit power. The one or more instructions, when executed by one or more processors, may cause the one or more processors to receive the second PDSCH in accordance with the second transmit power.

Another innovative aspect of the subject matter described in this disclosure can be implemented in an apparatus for wireless communication. The apparatus may include means for receiving a configuration that indicates a first transmit power associated with a first PDSCH and a second transmit power associated with a second PDSCH, where the first transmit power is different than the second transmit power. The apparatus may include means for receiving the first PDSCH in accordance with the first transmit power. The apparatus may include means for receiving the second PDSCH in accordance with the second transmit power.

Another innovative aspect of the subject matter described in this disclosure can be implemented in a method of wireless communication performed by an apparatus of a network node. The method may include transmitting, in an STC or an SMTC, a configuration that indicates a transmit power for an SSB. The method may include transmitting the SSB in accordance with the transmit power.

In some implementations, the method can include receiving the STC from a central unit.

In some implementations, the SMTC indicates transmit powers per cell or per group of cells.

In some implementations, the SSB is associated with inter-node discovery.

Another innovative aspect of the subject matter described in this disclosure can be implemented in an apparatus of a network node for wireless communication. The apparatus may include one or more interfaces configured to output, in an STC or an SMTC, a configuration that indicates a transmit power for an SSB. The one or more interfaces may be configured to output the SSB in accordance with the transmit power.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a network node, may cause the one or more processors to output, in an STC or an SMTC, a configuration that indicates a transmit power for an SSB. The one or more instructions, when executed by one or more processors, may cause the one or more processors to output the SSB in accordance with the transmit power.

Another innovative aspect of the subject matter described in this disclosure can be implemented in an apparatus for wireless communication. The apparatus may include means for transmitting, in an STC or an SMTC, a configuration that indicates a transmit power for an SSB. The apparatus may include means for transmitting the SSB in accordance with the transmit power.

Aspects generally include a method, apparatus, system, computer program product, non-transitory computer-readable medium, user equipment, base station, wireless communication device, or processing system as substantially described herein with reference to and as illustrated by the accompanying drawings and appendix.

Details of one or more implementations of the subject matter described in this disclosure are set forth in the accompanying drawings and the description. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example of a base station in communication with a user equipment (UE) in a wireless network.

FIG. 3 is a diagram illustrating examples of radio access networks (RANs).

FIG. 4 is a diagram illustrating an example of an integrated access and backhaul (IAB) network architecture.

FIG. 5 is a diagram illustrating an example of a synchronization signal (SS) hierarchy.

FIG. 6 is a diagram illustrating an example of a semi-static configuration providing variable synchronization signal block (SSB) transmit power.

FIG. 7 is a diagram illustrating an example of dynamic signaling providing adjustment of SSB transmit power.

FIG. 8 is a diagram illustrating an example of a semi-static configuration providing variable channel state information reference signal (CSI-RS) transmit power.

FIG. 9 is a diagram illustrating an example of signaling supporting adjustment of CSI-RS transmit power.

FIG. 10 is a diagram illustrating an example of a semi-static configuration providing variable SSB transmit power.

FIG. 11 is a diagram illustrating an example of signaling supporting adjustment of physical downlink shared channel (PDSCH) transmit power.

FIGS. 12-16 are diagrams illustrating example processes for variable downlink transmit power.

FIGS. 17-18 are diagrams of example apparatuses for wireless communication.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving radio frequency signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), IxEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G technology, 4G technology, 5G technology, or further implementations thereof.

A network node may transmit communications based on a transmit power. For example, a network node of a radio access network (RAN) or an integrated access and backhaul (IAB) network may perform downlink transmissions in accordance with a downlink transmit power. There are situations where it may be beneficial to adjust the downlink transmit power of a signal from transmission-to-transmission, or relative to an originally configured downlink transmit power of the signal. For example, in an IAB network, a child node of an IAB node may transmit downlink transmit power assistance information indicating a requested modification to downlink transmit power of the IAB node (such as for specific time resources or a spatial configuration associated with the child node). As another example, dynamic adaptation of downlink transmit power (such as using different transmit powers for a given signal at different times) may reduce energy consumption of the network, thereby realizing network energy savings. However, a given type of transmission, such as a downlink reference signal transmission or a physical downlink shared channel (PDSCH) transmission, may generally have a static or semi-static downlink transmit power, which may be expected not to vary across time.

As one example, a synchronization signal block (SSB) (used interchangeably with “synchronization signal / physical broadcast channel block” herein) may have a downlink transmit power defined by a fixed (semi-static) power configuration. A recipient of the SSB may expect that the downlink transmit power of the SSB does not vary between transmissions of the SSB. In such examples, changing the downlink transmit power of the SSB from transmission-to-transmission may involve transmission of system information or configuration information indicating the power configuration between each transmission of the SSB, which can involve significant overhead and time. Furthermore, power offsets between the reference signals that make up the SSB may be fixed and relatively small, which may reduce flexibility of SSB configuration and may limit the potential power savings achievable with regard to the SSB.

As another example, a channel state information (CSI) reference signal (CSI-RS) is a signal transmitted by a network node to enable a wireless communication device (such as a UE or a child node) to determine CSI regarding a channel (such as a propagation channel) between the network node and the wireless communication device. The downlink transmit power of the CSI-RS may be defined by an offset relative to a transmit power of a secondary synchronization signal (SSS). It may be beneficial to modify the downlink transmit power of the CSI-RS, for example, to manage interference, perform full-duplex communication, or save energy. However, modifying the downlink transmit power of the CSI-RS may involve reconfiguring one or more of the offset or the transmit power of the SSS, which may involve significant overhead and time.

As yet another example, a PDSCH may have a downlink transmit power that is defined by an offset relative to a transmit power of a CSI-RS. It may be beneficial to modify the downlink transmit power of the PDSCH, for example, to manage interference, perform full-duplex communication, or save energy. However, modifying the downlink transmit power of the PDSCH may involve reconfiguring one or more of the offset or the transmit power of the CSI-RS (or the SSS), which may involve significant overhead and time.

This disclosure provides systems, methods and apparatuses for adjustment of transmit powers for different transmissions of a reference signal. For example, some techniques and apparatuses described herein provide semi-static configuration or dynamic signaling such that a transmit power of an SSB can vary between SSBs of a burst set, between different SSB burst sets, or between different burst sets across periods. As another example, some techniques and apparatuses described herein provide semi-static configuration or dynamic signaling such that a transmit power of a CSI-RS can be modified from CSI-RS transmission to CSI-RS transmission. As yet another example, some techniques and apparatuses described herein provide modification of a transmit power of a PDSCH from transmission to transmission (such as using semi-static configuration or dynamic signaling).

Particular implementations of the subject matter described in this disclosure can be implemented to realize one or more of the following potential advantages. By modifying transmit power of an SSB, CSI-RS, or PDSCH using the techniques described herein, a network node may reduce interference and enable full-duplex or enhanced duplex operation for child nodes. Furthermore, the network node may conserve energy by modifying transmit power of an SSB, CSI-RS, or PDSCH, such as from transmission-to-transmission. Still further, the techniques described herein may reduce overhead relative to reconfiguring (such as semi-statically reconfiguring) an SSB, a CSI-RS resource, or a PDSCH each time a transmit power is to be modified.

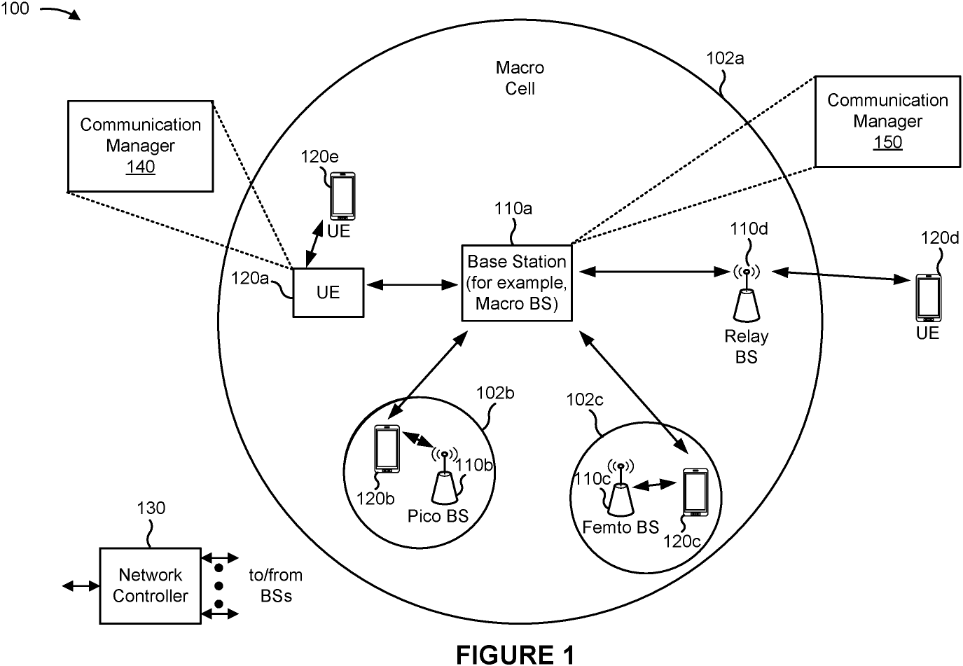

FIG. 1 is a diagram illustrating an example of a wireless network 100. The wireless network 100 may be or may include elements of a 5G (for example, NR) network or a 4G (for example, LTE) network, among other examples. The wireless network 100 may include one or more base stations 110 (shown as a base station (BS) 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells.

In some examples, a cell may not necessarily be stationary, and the geographic area of the cell may move according to the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5GNR, two initial operating bands have been identified as frequency range designations FR1 (410 MHz - 7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz - 114.25 GHz), and FR5 (114.25 GHz - 300 GHz). Each of these higher frequency bands falls within the EHF band.

With these examples in mind, unless specifically stated otherwise, it should be understood that the term “sub-6 GHz,” if used herein, may broadly represent frequencies that may be less than 6 GHz, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a network node (described in more detail elsewhere herein) may include a communication manager 150. As described in more detail elsewhere herein, the communication manager 150 may transmit a configuration that indicates a first transmit power associated with a first transmission of a downlink reference signal and a second transmit power associated with a second transmission of the downlink reference signal, where the first transmit power is different than the second transmit power; transmit the first transmission of the downlink reference signal in accordance with the first transmit power; and transmit the second transmission of the downlink reference signal in accordance with the second transmit power. In some aspects, the communication manager 150 may transmit a configuration that indicates a first transmit power associated with a first PDSCH and a second transmit power associated with a second PDSCH, where the first transmit power is different than the second transmit power; transmit the first PDSCH in accordance with the first transmit power; and transmit the second PDSCH in accordance with the second transmit power. In some aspects, the communication manager 150 may transmit, in an SSB transmission configuration (STC) or an SSB measurement timing configuration (SMTC), a configuration that indicates a transmit power for an SSB; and transmit the SSB in accordance with the transmit power.

In some aspects, a wireless communication device (described in more detail elsewhere herein) may include a communication manager 140. As described in more detail elsewhere herein, the communication manager 140 may receive a configuration that indicates a first transmit power associated with a first transmission of a downlink reference signal and a second transmit power associated with a second transmission of the downlink reference signal, where the first transmit power is different than the second transmit power; receive the first transmission of the downlink reference signal in accordance with the first transmit power; and receive the second transmission of the downlink reference signal in accordance with the second transmit power. In some aspects, the communication manager 140 may receive a configuration that indicates a first transmit power associated with a first PDSCH and a second transmit power associated with a second PDSCH, where the first transmit power is different than the second transmit power; receive the first PDSCH in accordance with the first transmit power; and receive the second PDSCH in accordance with the second transmit power. Additionally, or alternatively, the communication manager 140 may perform one or more other operations described herein.

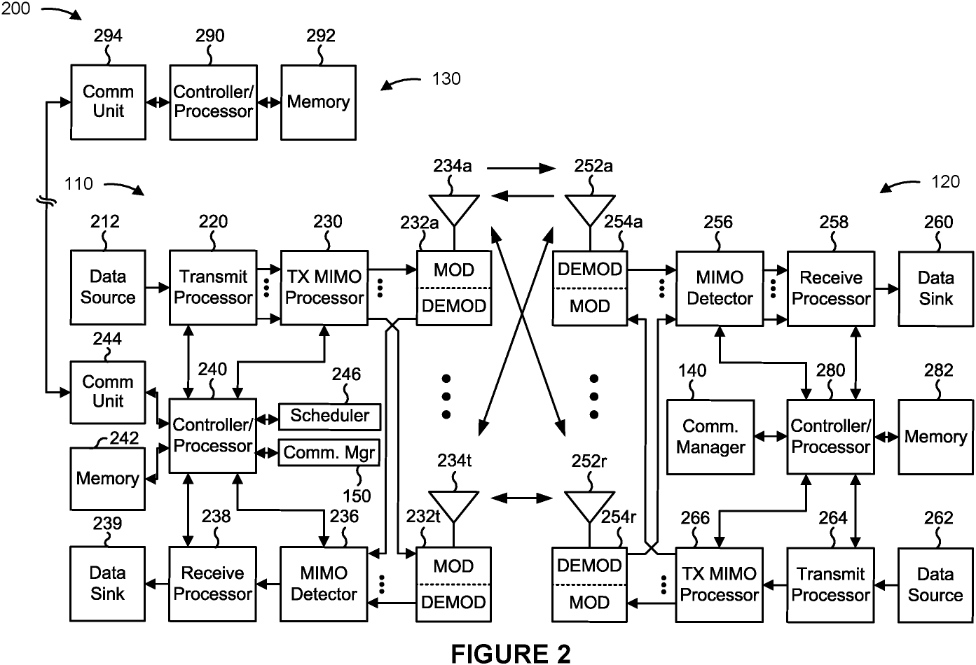

FIG. 2 is a diagram illustrating an example 200 of a base station 110 in communication with a UE 120 in a wireless network 100. The base station 110 may be equipped with a set of antennas 234a through 234t, such as T antennas (T≥ 1). The UE 120 may be equipped with a set of antennas 252a through 252r, such as R antennas (R ≥ 1).

At the base station 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The base station 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or an SSS). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, Tmodems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the base station 110). For example, a processing system of the base station 110 may be a system that includes the various other components or subcomponents of the base station 110.

The processing system of the base station 110 may interface with one or more other components of the base station 110, may process information received from one or more other components (such as inputs or signals), or may output information to one or more other components. For example, a chip or modem of the base station 110 may include a processing system, a first interface to receive or obtain information, and a second interface to output, transmit, or provide information. In some examples, the first interface may be an interface between the processing system of the chip or modem and a receiver, such that the base station 110 may receive information or signal inputs, and the information may be passed to the processing system. In some examples, the second interface may be an interface between the processing system of the chip or modem and a transmitter, such that the base station 110 may transmit information output from the chip or modem. A person having ordinary skill in the art will readily recognize that the second interface also may obtain or receive information or signal inputs, and the first interface also may output, transmit, or provide information.

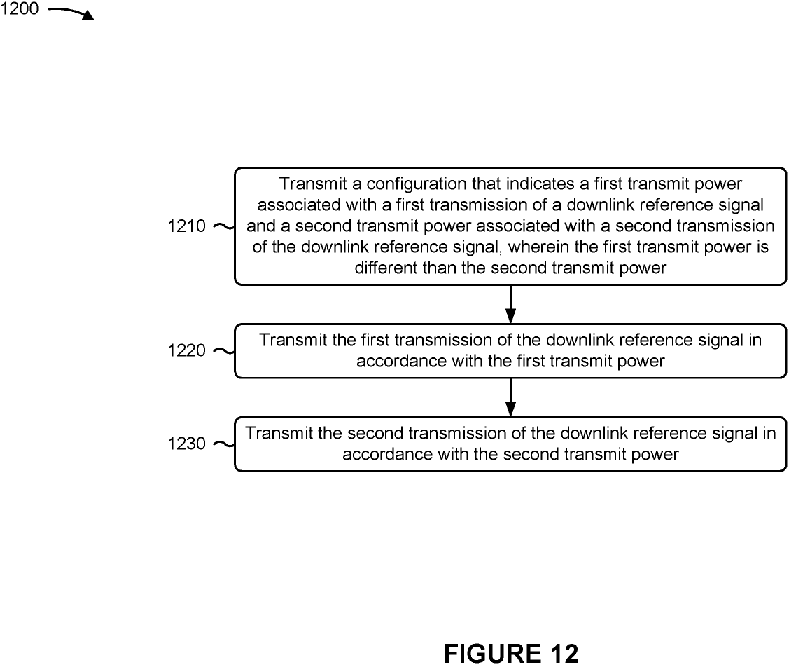

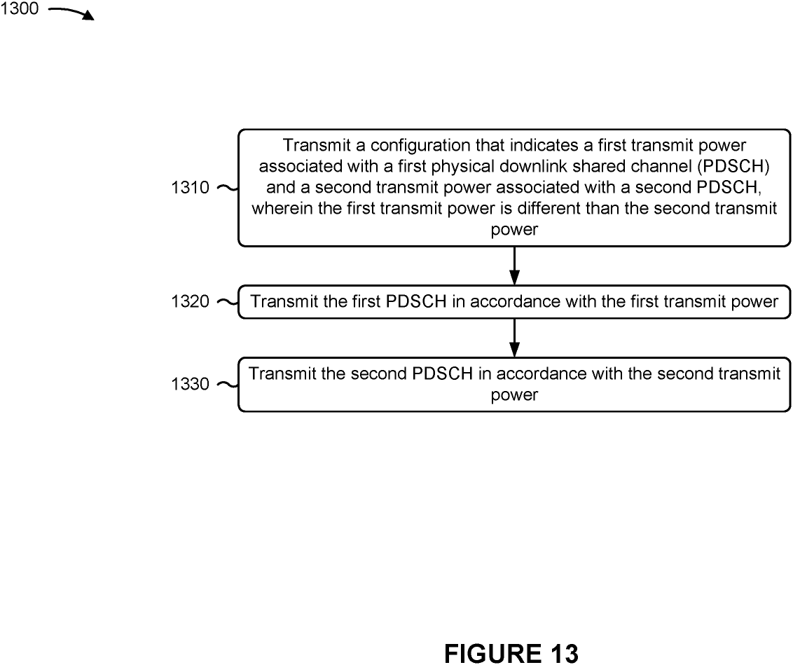

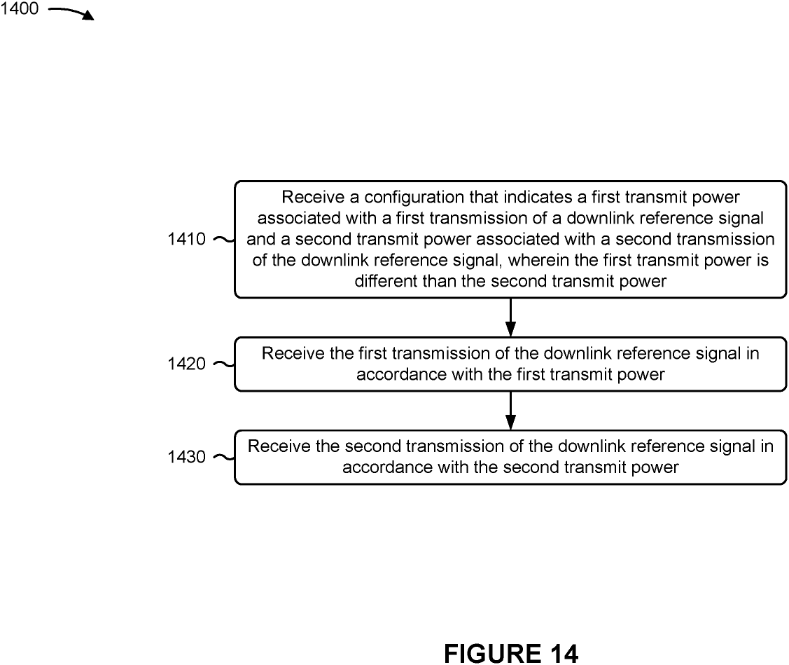

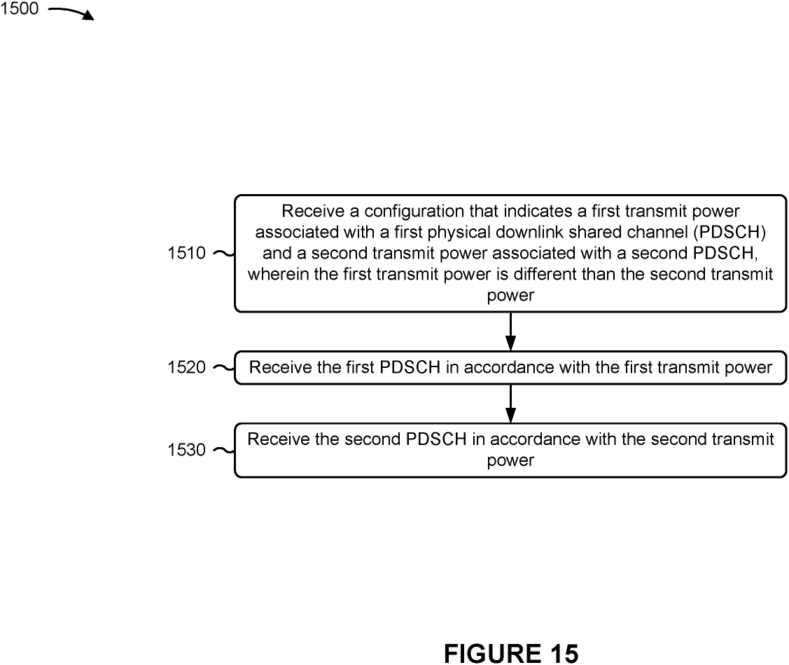

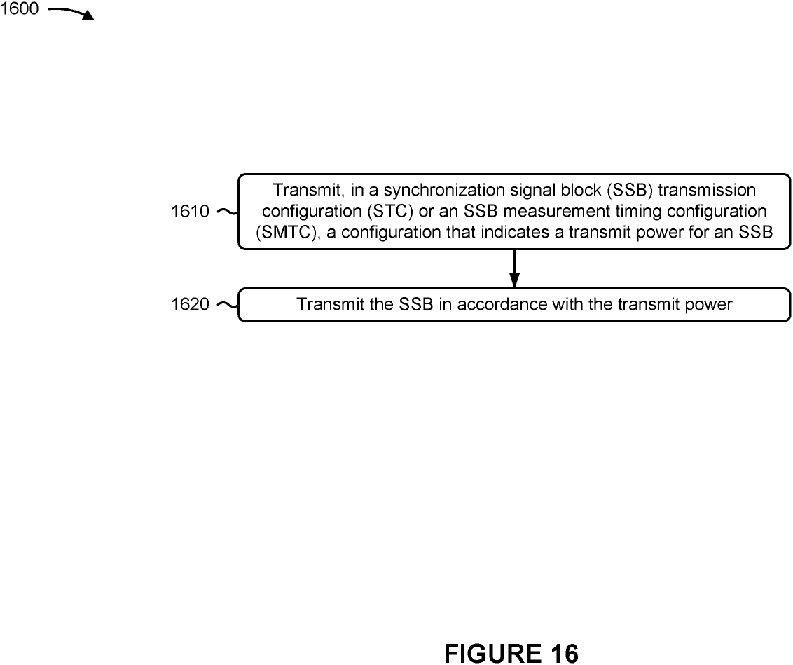

The controller/processor 240 of the base station 110, the controller/processor 280 of the UE 120, or any other component(s) of FIG. 2 may perform one or more techniques associated with downlink transmit power adjustment, as described in more detail elsewhere herein. In some aspects, the network node described herein is the base station 110, is included in the base station 110, or includes one or more components of the base station 110 shown in FIG. 2. In some aspects, the wireless communication device described herein is the UE 120, is included in the UE 120, or includes one or more components of the UE 120 shown in FIG. 2. For example, the controller/processor 240 of the base station 110, the controller/processor 280 of the UE 120, or any other component(s) (or combinations of components) of FIG. 2 may perform or direct operations of, for example, the process 1200 of FIG. 12, the process 1300 of FIG. 13, the process 1400 of FIG. 14, the process 1500 of FIG. 15, the process 1600 of FIG. 16, or other processes as described herein. The memory 242 and the memory 282 may store data and program codes for the base station 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, the process 1200 of FIG. 12, the process 1300 of FIG. 13, the process 1400 of FIG. 14, the process 1500 of FIG. 15, the process 1600 of FIG. 16, or other processes as described herein. In some examples, executing instructions may include running the instructions, converting the instructions, compiling the instructions, or interpreting the instructions.

In some aspects, a network node (described elsewhere herein) includes means for transmitting a configuration that indicates a first transmit power associated with a first transmission of a downlink reference signal and a second transmit power associated with a second transmission of the downlink reference signal, where the first transmit power is different than the second transmit power; means for transmitting the first transmission of the downlink reference signal in accordance with the first transmit power; and means for transmitting the second transmission of the downlink reference signal in accordance with the second transmit power. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the network node includes means for transmitting a configuration that indicates a first transmit power associated with a first PDSCH and a second transmit power associated with a second PDSCH, where the first transmit power is different than the second transmit power; means for transmitting the first PDSCH in accordance with the first transmit power; or means for transmitting the second PDSCH in accordance with the second transmit power. In some aspects, the network node includes means for transmitting, in an STC or an SMTC, a configuration that indicates a transmit power for an SSB; or means for transmitting the SSB in accordance with the transmit power.

In some aspects, a wireless communication device (described elsewhere herein) includes means for receiving a configuration that indicates a first transmit power associated with a first transmission of a downlink reference signal and a second transmit power associated with a second transmission of the downlink reference signal, where the first transmit power is different than the second transmit power; means for receiving the first transmission of the downlink reference signal in accordance with the first transmit power; or means for receiving the second transmission of the downlink reference signal in accordance with the second transmit power. In some aspects, the means for the wireless communication device to perform operations described herein may include, for example, one or more of communication manager 140, transmit processor 220, TX MIMO processor 230, modem 232, antenna 234, MIMO detector 236, receive processor 238, controller/processor 240, memory 242, or scheduler 246. In some aspects, the wireless communication device includes means for receiving a configuration that indicates a first transmit power associated with a first PDSCH and a second transmit power associated with a second PDSCH, where the first transmit power is different than the second transmit power; means for receiving the first PDSCH in accordance with the first transmit power; or means for receiving the second PDSCH in accordance with the second transmit power.

While blocks in FIG. 2 are illustrated as distinct components, the functions described with respect to the blocks may be implemented in a single hardware, software, or combination component or in various combinations of components. For example, the functions described with respect to the transmit processor 264, the receive processor 258, the TX MIMO processor 266, or another processor may be performed by or under the control of the controller/processor 280.

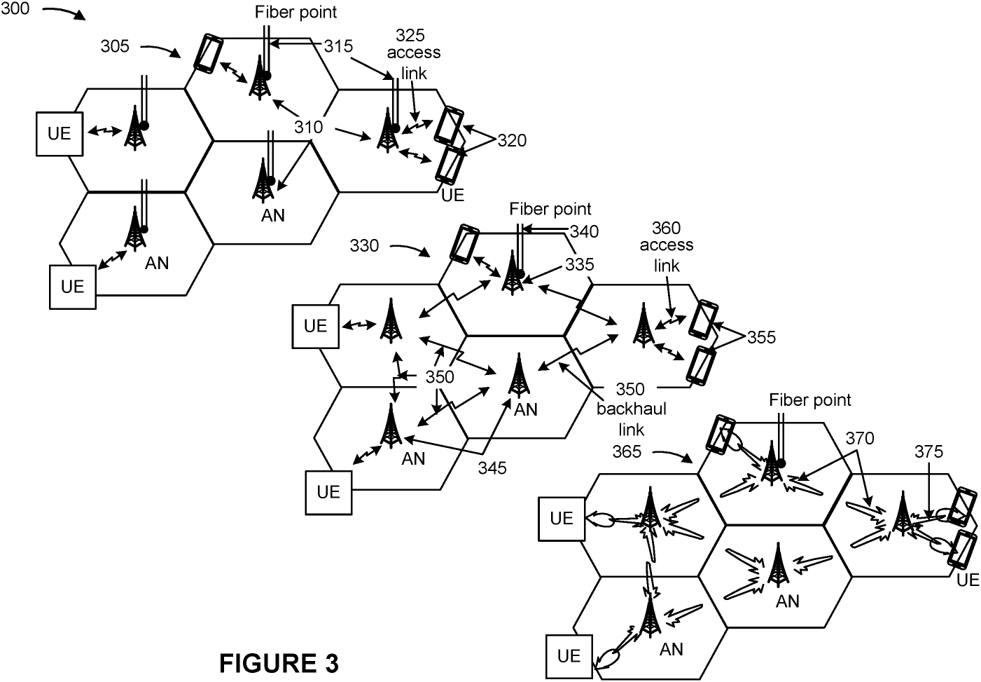

FIG. 3 is a diagram 300 illustrating examples of RANs. As shown by reference number 305, a traditional RAN, such as 3G, 4G, LTE, 5G and so on, may include multiple base stations 310 (shown as access nodes (AN)), where each base station 310 communicates with a core network via a wired backhaul link 315, such as a fiber connection. A base station 310 may communicate with a UE 320 via an access link 325, which may be a wireless link. In some aspects, a base station 310 shown in FIG. 3 may be a base station 110 shown in FIG. 1. In some aspects, a UE 320 shown in FIG. 3 may be a UE 120 shown in FIG. 1.

As shown by reference number 330, a RAN may include a wireless backhaul network, sometimes referred to as an IAB network. In an IAB network, at least one base station is an anchor base station 335 that communicates with a core network via a wired backhaul link 340, such as a fiber connection. An anchor base station 335 may also be referred to as an IAB donor (or IAB-donor). The IAB network may include one or more non-anchor base stations 345, sometimes referred to as relay base stations or IAB nodes (or IAB-nodes). The non-anchor base station 345 may communicate directly or indirectly with the anchor base station 335 via one or more backhaul links 350 (such as via one or more non-anchor base stations 345) to form a backhaul path to the core network for carrying backhaul traffic. Backhaul link 350 may be a wireless link. Anchor base station(s) 335 and non-anchor base station(s) 345 may communicate with one or more UEs 355 via access links 360, which may be wireless links for carrying access traffic. In some aspects, an anchor base station 335 or a non-anchor base station 345 shown in FIG. 3 may be a base station 110 shown in FIG. 1. In some aspects, a UE 355 shown in FIG. 3 may be a UE 120 shown in FIG. 1.

As shown by reference number 365, in some aspects, a radio access network that includes an IAB network may utilize millimeter wave technology or directional communications (such as beamforming) for communications between base stations and UEs (that is, between two base stations, between two UEs, or between a base station and a UE). For example, wireless backhaul links 370 between base stations may use millimeter wave (mmWave) signals to carry information, and may be directed toward a target base station using beamforming. Similarly, the wireless access links 375 between a UE and a base station may use millimeter wave signals and may be directed toward a target wireless node (such as a UE or a base station) using beamforming. In this way, inter-link interference may be reduced.

Some techniques described herein enable transmission of an SSB using a transmit power configuration that is associated with a duplexing mode of a transmitter wireless node or a receiver wireless node of the SSB. For example, some IAB networks may use full duplex (FD) communication to increase throughput and improve resource utilization. FD communication presents certain challenges, such as self-interference, adherence to transmit power limits during transmission, and maintaining an acceptable signal to interference plus noise ratio (SINR) at a receiver wireless node operating in an FD mode. By configuring SSBs with different transmit power configurations associated with different duplexing modes, FD communication performance of a transmitter wireless node (such as an anchor base station 335 or a non-anchor base station 345) and a receiver wireless node (such as a non-anchor base station or a UE 355) may be improved.

The configuration of base stations and UEs in FIG. 3 is shown as an example, and other examples are contemplated. For example, one or more base stations illustrated in FIG. 3 may be replaced by one or more UEs that communicate via a UE-to-UE access network (such as a peer-to-peer network or a device-to-device network). In this case, “anchor node” may refer to a UE that is directly in communication with a base station (such as an anchor base station or a non-anchor base station).

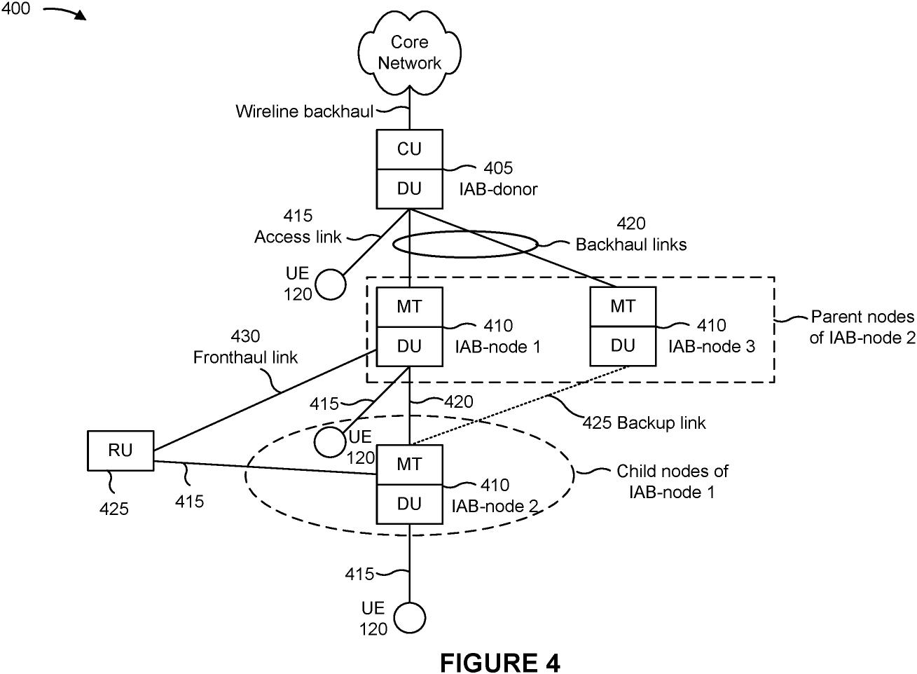

FIG. 4 is a diagram 400 illustrating an example of an IAB network architecture. As shown in FIG. 4, an IAB network may include an IAB donor 405 (shown as IAB-donor) that connects to a core network via a wired connection (shown as a wireline backhaul). For example, an Ng interface of an IAB donor 405 may terminate at a core network. Additionally, or alternatively, an IAB donor 405 may connect to one or more devices of the core network that provide a core access and mobility management function (AMF). In some aspects, an IAB donor 405 may include a base station 110, such as an anchor base station, as described in connection with FIG. 3. As shown, an IAB donor 405 may include a central unit (CU) (also referred to herein as a central node), which may perform access node controller (ANC) functions and AMF functions. The CU may configure one or more distributed units (DUs) of the IAB donor 405 and may configure one or more IAB nodes 410 (such as a mobile termination (MT) unit or a DU of an IAB node 410) that connect to the core network via the IAB donor 405. In some aspects, the CU may handle configuration of sets of SSBs with different transmit power configurations, resource configurations for a DU or an MT, or other configurations described herein. Thus, a CU of an IAB donor 405 may control and configure the entire IAB network that connects to the core network via the IAB donor 405, such as by using control messages and configuration messages (such as a radio resource control (RRC) configuration message or an F1 application protocol (F1AP) message). In some aspects, the one or more DUs may include an open RAN (O-RAN) DU and an O-RAN radio unit (RU), as described herein. In some aspects, the CU may be referred to herein as a control node.

In some aspects, the IAB network architecture may support disaggregated RAN operability, such as O-RAN operability, virtual RAN (vRAN) operability, or another form of disaggregated RAN operability. O-RAN provides for disaggregation of hardware and software, as well as interfacing between hardware and software. In some aspects, O-RAN may use an architecture with a CU (such as a CU of IAB donor 405), one or more DUs (which may be termed an O-RAN DU or O-DU), and one or more RUs (which may be termed an O-RAN RU or O-RU). The RU may host a first set of functions. The DU may host a second set of functions. The CU may host a third set of functions. The first set of functions, the second set of functions, and the third set of functions may generally include protocol functions of the RAN. The protocol functions hosted by a particular unit (of the RU, the DU, or the CU) may be determined according to a functional split. In one example, the RU may perform digital front end functions, some physical layer functions, digital beamforming, and so on. In this example, the DU may handle radio link control (RLC), medium access control (MAC), and some physical (PHY) layer functions. In this example, the CU may handle certain gNB functions, such as transfer of user data, mobility control, RAN sharing, positioning, session management, and so on. The CU may control the operation of one or more DUs, and the one or more DUs may control the operation of one or more RUs. In some aspects, the one or more DUs may control low-PHY layer functions, such as over the air communication, by the one or more RUs. For example, a DU may cause an RU to transmit a downlink reference signal, or may output a reference signal for transmission by an RU, in accordance with a transmit power indicated by a configuration.

In some aspects, the CU may host one or more higher layer control functions. Such control functions can include RRC, packet data convergence protocol (PDCP), and service data adaptation protocol (SDAP). Each control function can be implemented with an interface configured to communicate signals with other control functions hosted by the CU. The CU may be configured to handle user plane functionality (i.e., Central Unit - User Plane (CU-UP)), control plane functionality (i.e., Central Unit - Control Plane (CU-CP)), or a combination thereof. In some implementations, the CU can be logically split into one or more CU-UP units and one or more CU-CP units. The CU can be implemented to communicate with the DU, as necessary, for network control and signaling.

The DU may correspond to a logical unit that includes one or more base station functions to control the operation of one or more RUs. In some aspects, the DU may host one or more of an RLC layer, a MAC layer, and one or more high PHY layers (such as modules for forward error correction (FEC) encoding and decoding, scrambling, or modulation and demodulation, among other examples) depending, at least in part, on a lower layer functional split. Each layer (or module) can be implemented with an interface configured to communicate signals with other layers (and modules) hosted by the DU, or with the control functions hosted by the CU.

Lower-level functionality can be implemented by one or more RUs. In some deployments, an RU, controlled by a DU, may correspond to a logical node that hosts radio frequency processing functions, or low-PHY layer functions (such as performing fast Fourier transform (FFT), inverse FFT (iFFT), digital beamforming, or physical random access channel (PRACH) extraction and filtering, among other examples), or both, based on the lower layer functional split. In such an architecture, the RU(s) can be implemented to handle over the air (OTA) communication (such as downlink transmission including downlink reference signal transmission, or uplink reception) with a UE 120. In some implementations, real-time and non-real-time aspects of control and user plane communication with the RU(s) can be controlled by the corresponding DU. In some scenarios, this configuration can enable the DU(s) and the CU to be implemented in a cloud-based RAN architecture, such as a vRAN architecture. As used herein, “network node” can refer to an RU, a DU, a CU, a base station, or one or more entities of a disaggregated base station.

As further shown in FIG. 4, the IAB network may include IAB nodes 410 (shown as IAB-node 1, IAB-node 2, and IAB-node 3) that connect to the core network via the IAB donor 405. As shown, an IAB node 410 may include MT functions (also sometimes referred to as UE functions (UEF)) and may include DU functions (also sometimes referred to as access node functions (ANF)). The MT functions of an IAB node 410 (referred to as a child node) may be controlled and scheduled by another IAB node 410 (referred to as a parent node of the child node) or by an IAB donor 405. The DU functions of an IAB node 410 (a parent node) may control and schedule other IAB nodes 410 (child nodes of the parent node) and UEs 120. Thus, a DU may be referred to as a scheduling node or a scheduling component, and an MT may be referred to as a scheduled node or a scheduled component. In some aspects, an IAB donor 405 may include DU functions and not MT functions. That is, an IAB donor 405 may configure, control, and schedule communications of IAB nodes 410 and UEs 120. A UE 120 may include only MT functions, and not DU functions. That is, communications of a UE 120 may be controlled and scheduled by an IAB donor 405 or an IAB node 410 (such as a parent node of the UE 120).

When a first node controls and schedules communications for a second node (such as when the first node provides DU functions for the second node’s MT functions), the first node may be referred to as a parent node of the second node, and the second node may be referred to as a child node of the first node. A child node of the second node may be referred to as a grandchild node of the first node. Thus, a DU function of a parent node may control and schedule communications for child nodes of the parent node. A parent node may be an IAB donor 405 or an IAB node 410, and a child node may be an IAB node 410 or a UE 120. Communications of an MT function of a child node may be controlled and scheduled by a parent node of the child node.

As further shown in FIG. 4, a link between a UE 120 (where the UE 120 only has MT functions, and not DU functions) and an IAB donor 405, or between a UE 120 and an IAB node 410, may be referred to as an access link 415. Access link 415 may be a wireless access link that provides a UE 120 with radio access to a core network via an IAB donor 405, and optionally via one or more IAB nodes 410. Thus, the network illustrated in FIG. 4 may be referred to as a multi-hop network or a wireless multi-hop network.

As further shown in FIG. 4, a link between an IAB donor 405 and an IAB node 410 or between two IAB nodes 410 may be referred to as a backhaul link 420. Backhaul link 420 may be a wireless backhaul link that provides an IAB node 410 with radio access to a core network via an IAB donor 405, and optionally via one or more other IAB nodes 410. In an IAB network, network resources for wireless communications (such as time resources, frequency resources, and spatial resources) may be shared between access links 415 and backhaul links 420. In some aspects, a backhaul link 420 may be a primary backhaul link or a secondary backhaul link (also referred to as a backup backhaul link). In some aspects, a secondary backhaul link may be used if a primary backhaul link fails, becomes congested, or becomes overloaded. For example, a backup link between IAB-node 2 and IAB-node 3 may be used for backhaul communications if a primary backhaul link between IAB-node 2 and IAB-node 1 fails. As used herein, “node” or “wireless node” may refer to an IAB donor 405 or an IAB node 410, among other examples described elsewhere herein.

In some aspects, an IAB node 410 (a parent node) may be unable to communicate with another IAB node 410 (a child node) using a direct access link. For example, IAB-node 2 may be outside of a communication range of IAB-node 1, or the direct access link between IAB-node 1 and IAB-node 2 may be blocked. IAB-node 1 may utilize an RU node 425 (such as a relay node, a radio unit, or a repeater node) to communicate with IAB-node 2. The IAB-node 1 (that is, the DU of IAB-node 1) may communicate with the RU node 425 using a fronthaul link 430, which can be wired or wireless. For example, the IAB-node 1 may transmit a communication to the RU node 425 using the fronthaul link 430. The RU node 425 may forward the communication to the IAB-node 2 using an access link 415 between the IAB-node 2 and the RU node 425. In this way, the IAB-node 1 may extend coverage of the IAB-node 1 and communicate with the IAB-node 2 when the IAB-node 1 is unable to use a direct access link between IAB-node 1 and IAB-node 2 for direct communications. Some techniques described herein enable configuration and transmission of SSBs using different transmit power configurations, such as to improve performance and facilitate successful communication in different duplexing modes.

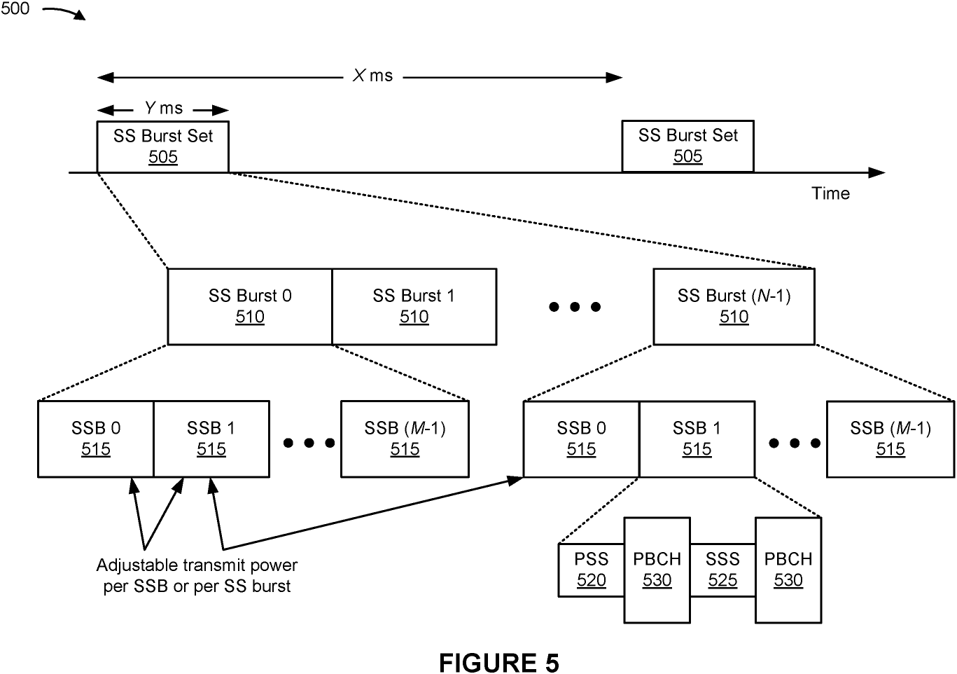

FIG. 5 is a diagram 500 illustrating an example of a synchronization signal (SS) hierarchy. As shown in FIG. 5, the SS hierarchy may include an SS burst set 505, which may include multiple SS bursts 510, shown as SS burst 0 through SS burst N-1, where N is a maximum number of repetitions of the SS burst 510 that may be transmitted by the base station. As further shown, each SS burst 510 may include one or more SSBs 515, shown as SSB 0 through SSB M-1, where M is a maximum number of SSBs 515 that can be carried by an SS burst 510. In some aspects, different SSBs 515 may be beam-formed differently (for example, transmitted using different beams), and may be used for cell search, cell acquisition, beam management, beam selection (such as part of an initial network access procedure), RRM, radio link monitoring (RLM), or similar operations. A receiver wireless node, such as a UE 120, may perform measurement and reporting of SSBs 515 in association with these operations. An SS burst set 505 may be periodically transmitted by a transmitter wireless node (such as base station 110, an IAB node, an IAB donor, a TRP, or a UE in a sidelink network), such as every X milliseconds, as shown in FIG. 5. In some aspects, an SS burst set 505 may have a fixed or dynamic length, shown as Y milliseconds in FIG. 5. In some cases, an SS burst set 505 or an SS burst 510 may be referred to as a discovery reference signal (DRS) transmission window or an SMTC window. SSBs 515 can also be used for backhaul discovery, such as using an STC.

In some aspects, an SSB 515 may include resources that carry a PSS 520, an SSS 525, and a physical broadcast channel (PBCH) 530. In some aspects, multiple SSBs 515 are included in an SS burst 510 (with transmission on different beams), and the PSS 520, the SSS 525, and the PBCH 530 may be the same across each SSB 515 of the SS burst 510. In some aspects, a single SSB 515 may be included in an SS burst 510. In some aspects, the SSB 515 may be at least four symbols (such as OFDM symbols) in length, where each symbol carries one or more of the PSS 520 (occupying one symbol), the SSS 525 (occupying one symbol), or the PBCH 530 (occupying two symbols). In some aspects, an SSB 515 may be referred to as an SS/PBCH block.

In some aspects, the symbols of an SSB 515 are consecutive, as shown in FIG. 5. In some aspects, the symbols of an SSB 515 are non-consecutive. Similarly, in some aspects, one or more SSBs 515 of the SS burst 510 may be transmitted in consecutive radio resources (such as consecutive symbols) during one or more slots. Additionally, or alternatively, one or more SSBs 515 of the SS burst 510 may be transmitted in non-consecutive radio resources.

In some aspects, the SS bursts 510 may have a burst period, and the SSBs 515 of the SS burst 510 may be transmitted by a transmitter wireless node according to the burst period. In this case, the SSBs 515 may be repeated during each SS burst 510. In some aspects, the SS burst set 505 may have a burst set periodicity, whereby the SS bursts 510 of the SS burst set 505 are transmitted by the wireless node according to the fixed burst set periodicity. In other words, the SS bursts 510 may be repeated during each SS burst set 505.

In some aspects, an SSB 515 may include an SSB index, which may correspond to a beam used to carry the SSB 515. A receiver wireless node (such as a UE 120, a base station, or an IAB node) may monitor for and measure SSBs 515 using different receive (Rx) beams during an initial network access procedure or a cell search procedure, among other examples. Based on the monitoring and measuring, the receiver wireless node may indicate one or more SSBs 515 with a best signal parameter (such as an RSRP parameter, in some examples) to a transmitter wireless node. The transmitter wireless node and the receiver wireless node may use the one or more indicated SSBs 515 to select one or more beams to be used for communication between the transmitter wireless node and the receiver wireless node (such as for a random access channel (RACH) procedure). Additionally, or alternatively, the receiver wireless node may use the SSB 515 or the SSB index to determine a cell timing for a cell via which the SSB 515 is received (for example, a serving cell).

As shown, the techniques described herein provide adjustment of transmit power of an SSB, such as from SSB to SSB within an SS burst or burst set (for example, SSB 0 and SSB 1 of SS Burst 0), from SS burst set to SS burst set, or based on a periodicity.

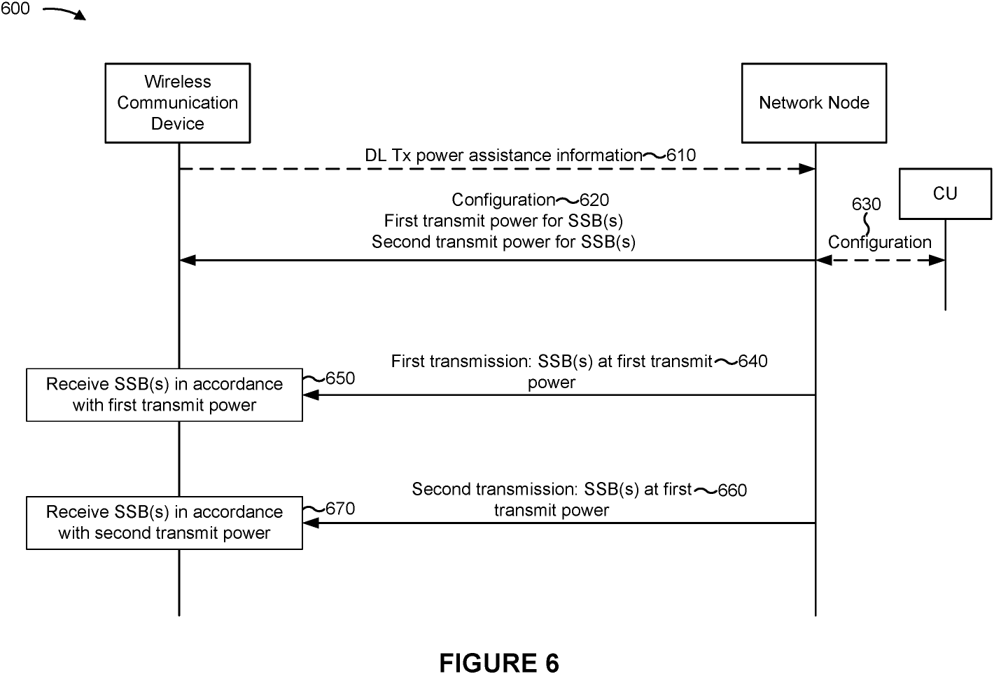

FIG. 6 is a diagram illustrating an example 600 of a semi-static configuration providing variable SSB transmit power. As shown, example 600 includes a network node, a wireless communication device, and optionally a CU. The network node may include, for example, a base station 110, an IAB node (such as the anchor base station 335, the non-anchor base station 345, the IAB donor 405, or the IAB node 410), a DU function of an IAB node, or an O-RAN DU. The wireless communication device may include, for example, a UE 120 or a UE 355, a base station 110, an IAB node (such as the non-anchor base station 345 or the IAB node 410), an MT function of an IAB node, or an O-RAN MT. The CU may include, for example, a base station 110, an anchor base station 335, a CU function of an IAB donor 405, or an O-RAN CU.

As shown in FIG. 6, and by reference number 610, the wireless communication device may optionally transmit downlink (DL) transmit (Tx) power assistance information to the network node. In some aspects, the DL Tx power assistance information may request a downlink transmit power for a reference signal or an adjustment to a downlink transmit power for a reference signal. In some aspects, the DL Tx power assistance information may indicate a mode of operation of the wireless communication device, such as a full-duplex mode, an enhanced duplex mode, or a low power mode.

As shown by reference number 620, the network node may transmit a configuration to the wireless communication device. In example 600, the configuration may be a semi-static configuration, such as may be communicated via RRC signaling. The configuration may indicate a first downlink transmit power for a first set of SSBs and a second downlink transmit power for a second set of SSBs. In some aspects, the configuration may indicate a downlink transmit power using an absolute value. In some other aspects, the configuration may indicate a downlink transmit power using an offset value. For example, the configuration may indicate the second downlink transmit power using an offset relative to the first downlink transmit power. As another example, the configuration may indicate a downlink transmit power using an offset relative to a reference transmit power (such as a previously configured downlink transmit power).

In some aspects, the network node may transmit the configuration via remaining minimum system information (RMSI, sometimes referred to as SIB1, which may be provided in minimum system information (MSI) with a master information block (MIB)) or a dedicated RRC message (such as for a cell-defining SSB (CD-SSB)). In some aspects, the network node may transmit the configuration via a backhaul, such as over an F1 interface. For example, the network node may transmit the configuration via an STC or a TRP SSB configuration.

In some aspects, the network node may transmit the configuration via a synchronization signal / physical broadcast channel block based RRM measurement timing configuration (SMTC) (sometimes referred to as an SSB measurement timing configuration or an SSB based RRM measurement timing configuration). For example, an SMTC may indicate multiple downlink transmit powers for a cell or a group of cells. The multiple downlink transmit powers may be associated with different sets of SSBs.

In some aspects, the configuration may relate to one or more resources. For example, the configuration may indicate a downlink transmit power to be used for a set of time resources. In some aspects, the set of time resources may be explicitly indicated. In some aspects, the set of time resources may be indicated at the slot granularity, the symbol granularity, or another granularity. In some aspects, a set of downlink transmit powers (such as a set of absolute transmit powers or a set of offsets) [PA_0 , PA_1 , ... , PA_N-1] may be provided for a set of N time resources. In some aspects, the set of downlink transmit powers may be in a configured range (such as with a maximum transmit power or transmit power adjustment, a minimum transmit power or transmit power adjustment, or a combination thereof). For example, the set of downlink transmit powers may be in a configured range of -8 dB to 15 dB. In some aspects, the configuration may indicate a pattern of downlink transmit powers (such as PA 0, PA 1, PA 2), which may repeat until an Nth time resource, where N is greater than or equal to a number of downlink transmit powers indicated by the configuration. In some aspects, the pattern may be a first pattern, and the network node may provide a second pattern subsequent to the first pattern. In some aspects, the second pattern may overwrite the first pattern for one or more time resources to which the first pattern and the second pattern can both apply. In some other aspects, the second pattern may be mandated to indicate the same downlink transmit power(s) for the one or more time resources to which the first pattern and the second pattern can both apply. In some aspects, when applying the indicated downlink transmit power(s) to time resources, the network node (or the wireless communication device that receives the configuration) may skip uplink resources (such as semi-statically configured uplink resources, dynamically indicated uplink resources, flexible resources that are configured to have an uplink transmission, or a combination thereof).

In some aspects, the configuration may relate to one or more signals or types of signals. For example, a downlink transmit power for a set of time resources may be applicable to one or more types of downlink symbols, such as one or more of a PDSCH, a semi-statically configured PDSCH, a dynamically scheduled PDSCH, a DMRS or phase tracking reference signal (PTRS) associated with a PDSCH, a physical downlink control channel (PDCCH), a subset of PDCCHs (such as PDCCHs other than those for a DCI format 1_0 with a cyclic redundancy check scrambled by a system information (SI) radio network temporary identifier (RNTI), a paging RNTI (P-RNTI), or a random access RNTI (RA-RNTI)), a tracking reference signal, or a CSI-RS.

In some aspects, the configuration may relate to a communication with a set of parameters. For example, the set of parameters may include or indicate one or more of a component carrier used by the wireless communication device, a cell provided by the network node, a multiplexing mode of the network node, a multiplexing mode of the wireless communication device, a receive beam used by the wireless communication device, whether the wireless communication device’s downlink signal is multiplexed (such as in frequency) with another communication such as an uplink signal, whether the wireless communication device’s downlink signal at least partially overlaps in frequency with another communication, a bandwidth of a downlink signal associated with the downlink transmit power, a resource block allocation of the downlink signal, or a timing reference mode associated with at least one concurrent communication associated with the downlink transmit power. In some aspects, the configuration may indicate that a downlink transmit power applies to communications associated with a particular one of these parameters (such as a particular value of the parameter, a particular component carrier, a particular cell, a particular multiplexing mode, a particular receive beam, a particular multiplexing state, a particular overlap state, a particular bandwidth, a particular resource block allocation, or a particular timing reference mode). In some aspects, the configuration may indicate that the downlink transmit power applies to communications associated with a combination of these parameters (such as particular values of the combination of parameters).

In some aspects, the configuration may be based on a request from a wireless communication device. For example, the wireless communication device may transmit a request for a modified downlink transmit power to the network node. In some aspects, the request may be transmitted via MAC signaling. In some aspects, the request may indicate a negative adjustment (indicating to reduce the downlink transmit power). In some aspects, the request may indicate a positive adjustment (indicating to increase the downlink transmit power). For example, the request may support both negative adjustment and positive adjustment, which may be useful in different scenarios such as interference or power imbalance at the wireless communication device.

In some aspects, the configuration may be based on (such as may depend on, or may be derived from) a set of parameters. For example, the network node may determine the configuration based on the set of parameters. In some aspects, the set of parameters may include one or more of a component carrier used by the wireless communication device, a cell provided by the network node, a multiplexing mode of the network node, a multiplexing mode of the wireless communication device, a receive beam used by the wireless communication device, whether the wireless communication device’s downlink signal is multiplexed (such as in frequency) with another communication such as an uplink signal, whether the wireless communication device’s downlink signal at least partially overlaps in frequency with another communication, a bandwidth of a downlink signal associated with the downlink transmit power, a resource block allocation of the downlink signal, or a timing reference mode associated with at least one concurrent communication associated with the downlink transmit power.

A timing reference mode may indicate a timing reference for a wireless communication device or network node. For example, a timing reference mode may indicate a reference to which a wireless communication device or network node is to align timing of communications received or transmitted by the wireless communication device or network node.

In some aspects, a downlink transmit power may be configured per cell (such as via an SMTC). In some aspects, an SMTC may indicate a downlink transmit power per group of cells. In some aspects, each SMTC may indicate a downlink transmit power, and a cell or group of cells can be associated with multiple downlink transmit powers (such as based on multiple SMTCs). An SMTC may indicate a downlink transmit power using an absolute value or using an offset.

In some aspects, the first set of SSBs may be a first subset of SSBs of an SS burst set and the second set of SSBs may be a second subset of SSBs of the SS burst set. By indicating different downlink transmit powers for different subsets of SSBs of an SS burst set, the wireless communication device can configure beam-specific transmit power.

In some aspects, the first set of SSBs may be a first SS burst set and the second set of SSBs may be a second SS burst set. For example, the first SS burst set may be associated with a first purpose and the second SS burst set may be associated with a second purpose. A purpose is a set of information that defines how an SS burst will be used at the wireless communication device or the network node. A purpose can include, for example, initial access (such as using a CD-SSB), radio resource management (RRM) measurements, or inter-node discovery, among other examples. In some aspects, a purpose for a set of SSBs may be explicitly indicated (such as via the configuration shown by reference number 610). For example, the configuration may indicate a first downlink transmit power associated with a first purpose and a second downlink transmit power associated with a second purpose. In some other aspects, the configuration may indicate a first downlink transmit power for a first SS burst set and a second downlink transmit power for a second SS burst set (such as without explicit reference to a purpose).

In some aspects, the first set of SSBs may be a first subset of SS burst sets and the second set of SSBs may be a second subset of SS burst sets. For example, the first subset and the second subset may be defined based on a periodicity. The periodicity may indicate which SS burst sets are included in the first subset and which SS burst sets are included in the second subset. For example, a periodicity of ½ may indicate that even-indexed SS burst sets are included in the first subset and odd-indexed SS burst sets are included in the second subset. In this example, the downlink transmit power of all SSBs within an SS burst set may change in accordance with the configuration. In some aspects, the configuration may indicate whether an SS burst set belongs to a first set of SSBs or a second set of SSBs. For example, the configuration may indicate a bitmap, an offset, or a periodicity to indicate whether an SS burst set belongs to a first set of SSBs or a second set of SSBs. A first value of the bitmap may indicate that an SS burst set belongs to a first set of SSBs and a second value of the bitmap may indicate that an SS burst set belongs to a second set of SSBs.

In some aspects, the configuration may indicate the first set of SSBs or the second set of SSBs using a bitmap. For example, a first value of the bitmap may indicate that a corresponding SSB belongs to the first set of SSBs, and a second value of the bitmap may indicate that a corresponding SSB belongs to the second set of SSBs. In some aspects, the configuration may indicate the first set of SSBs or the second set of SSBs based on SSB indices of SSBs. For example, the configuration may include a list indicating SSB indices of SSBs associated with a downlink transmit power.

In some aspects, the configuration may indicate the first set of SSBs or the second set of SSBs based on a center frequency. For example, the configuration may indicate that SSBs with a particular center frequency belong to a particular set of SSBs. In some aspects, the configuration may indicate a set of SSBs based on a set of resources. For example, a set of SSB resources may be linked to a downlink transmit power.

In some aspects, the configuration may indicate a set of SSBs based on a mode of operation of the network node or the wireless communication device. For example, a first set of SSBs (configured with a first transmit power) may be associated with a first mode of operation, and a second set of SSBs (configured with a second transmit power) may be associated with a second mode of operation. As some examples, a mode of operation can include a multiplexing mode, such as a half-duplex mode, a full-duplex mode, an MT-transmit and DU-transmit mode in IAB, or an MT-receive and DU-transmit mode in IAB.

In some aspects, the configuration may indicate a set of SSBs based on a type of resource. For example, the configuration may indicate that SSBs associated with a downlink resource are associated with a first downlink transmit power, SSBs associated with a flexible resource are associated with a second downlink transmit power, and SSBs associated with a full-duplex resource are associated with a third downlink transmit power. Additionally, or alternatively, the configuration may indicate that SSBs associated with a hard resource are associated with a first downlink transmit power, SSBs associated with a soft resource are associated with a second downlink transmit power, and SSBs associated with a non-available resource are associated with a third downlink transmit power.

In some aspects, the configuration may indicate a first downlink transmit power for a first reference signal of an SSB and a second downlink transmit power for a second reference signal of an SSB. For example, the configuration may indicate a first downlink transmit power (such as a first energy per resource element (EPRE)) for a PBCH and a second downlink transmit power (such as a second EPRE) for an SSS. In some aspects, the second downlink transmit power may be indicated as an offset between the PBCH and the SSS. In some aspects, the offset may be selected from a range of offset values, such as [0, -3 dB, -6 dB, +3 dB], and may be indicated in the configuration (such as via an MIB or a SIB1). In some other aspects, the network node may transmit the PBCH and the SSS without indicating the offset to the wireless communication device. Indicating an offset between a PBCH and an SSS may enable a PBCH to be transmitted with a lower power for power saving, particularly in use cases where successful reception of the MIB is not needed, such as when SSBs are used primarily for discovery.

In some aspects, the configuration may indicate (such as via a MIB or SIB 1) an offset between a PSS downlink transmit power (such as an EPRE of the PSS) and an SSS downlink transmit power. For example, the offset may be selected from a range of offset values, such as [0, +3 dB, +6 dB, +9 dB]. Indicating a large offset between a PSS and an SSS, such as 6 dB or 9 dB, may improve detection reliability of the PSS while reducing energy consumption associated with the SSS. In some aspects, the offset may be selected from the range of offset values, and may not be indicated by the configuration.

As shown by reference number 630, in some aspects, the network node may transmit the configuration to a CU, or may receive the configuration from a CU, such as over an Xn interface. In some examples, the network node may include or may be included in a CU. In some aspects, the configuration may be provided in an STC. An STC is a configuration that may indicate a center frequency associated with one or more SSBs, a subcarrier spacing associated with one or more SSBs, a periodicity of transmission of one or more SSBs, a timing offset associated with transmission of one or more SSBs, one or more SSB indices of one or more SSBs, or a combination thereof. The techniques described herein provide for the STC to indicate a downlink transmit power for one or more SSBs indicated by the STC. In some aspects, the CU may provide the configuration to other nodes, such as one or more other network nodes or one or more other wireless communication devices. For example, the CU may provide the configuration over an F1 interface, an Xn interface, or another interface. An STC may indicate a downlink transmit power using an absolute value, or may indicate a downlink transmit power using an offset. In some aspects, an STC may indicate multiple downlink transmit powers (such as a first downlink transmit power and a second downlink transmit power) as described in connection with reference number 620. Providing the configuration in an STC may enable a CU to configure downlink transmit power for DU cells, which may be beneficial for energy savings and interference management. Furthermore, providing the configuration in an STC may enable the CU to determine the downlink transmit power used by a DU, which enables the CU to determine information regarding link quality. Still further, providing the configuration in an STC may enable different (or independent) downlink transmit powers to be used for SSBs associated with an access network and SSBs associated with backhaul operation.

In some aspects, a downlink transmit power may be configured per STC (for example, a downlink transmit power may be associated with a particular STC). For example, each STC may include information indicating a downlink transmit power, or a wireless communication device may be configured with information indicating a downlink transmit power to be used per STC. In some other aspects, a downlink transmit power may be configured per backhaul STC. For example, each backhaul STC may include information indicating a downlink transmit power, or a network node or wireless communication device may be configured with information indicating a downlink transmit power to be used per backhaul STC. A backhaul STC is an STC indicating a configuration for transmission of SSBs to support backhaul operations, and an access STC is an STC indicating a configuration for transmission of SSBs to support access network operations. In some aspects, a downlink transmit power may be configured for all STCs. For example, a wireless communication device or network node may be configured with information indicating a downlink transmit power to be used for all STCs. In some aspects, a downlink transmit power may be configured for all backhaul STCs. For example, a wireless communication device or network node may be configured with information indicating a downlink transmit power to be used for all backhaul STCs. In some aspects, an access STC may use a downlink transmit power indicated in a SIB, such as SIB 1.

As shown by reference number 640, the network node may transmit a first set of SSBs with the first downlink transmit power. As shown by reference number 650, the wireless communication device may receive the first set of SSBs in accordance with the first downlink transmit power. As shown by reference number 660, the network node may transmit a second set of SSBs with the second downlink transmit power. As shown by reference number 670, the wireless communication device may receive the second set of SSBs in accordance with the second downlink transmit power. For example, the wireless communication device may process a received SSB in accordance with the downlink transmit power configured for the received SSB.

In some aspects, the wireless communication device may perform an RRM measurement for an SSB. For example, the wireless communication device may perform the RRM measurement based on an indicated downlink transmit power, such as may be configured in an SMTC or for a cell or group of cells. The wireless communication device may scale or normalize a measured metric in accordance with the downlink transmit power. The wireless communication device may evaluate a triggering event (which may cause the wireless communication device to transmit triggering information based on detecting a triggering event using the scaled or normalized metric) or transmit reporting information using the scaled or normalized metric, such that an adjusted downlink transmit power of the SSB is taken into account. In some aspects, the wireless communication device may receive a configuration of a downlink transmit power for a cell (such as via RMSI) and may scale or normalize RRM measurements on SSBs of the cell accordingly. In some aspects, the wireless communication device may receive an RMSI indicating multiple downlink transmit powers, and may scale or normalize RRM measurements based on which downlink transmit power applies to a given SSB. By indicating the downlink transmit power of the SSB, the network node enables the wireless communication device to perform accurate RRM measurements, thereby determining more accurate information regarding channel or link quality.

In some aspects, the wireless communication device may perform a Layer 1 measurement on an SSB. A Layer 1 measurement on an SSB may include, for example, a synchronization signal reference signal received power (SS-RSRP), a synchronization signal reference signal received quality (SS-RSRQ), or a synchronization signal signal-to-interference-plus-noise ratio (SS-SINR). The wireless communication device may normalize a Layer 1 measurement on an SSB based on a downlink transmit power associated with the SSB. For example, the wireless communication device may apply a scaling factor to the Layer 1 measurement so that the downlink transmit power associated with the SSB is accounted for. In some aspects, the configuration may indicate the scaling factor. In some other aspects, the wireless communication device may determine the scaling factor based on a downlink transmit power indicated by the configuration. For example, the wireless communication device may determine the scaling factor based on at least one of the downlink transmit power used to transmit the SSB and a reference transmit power. In some aspects, the reference transmit power may be an original transmit power configured in SIB 1 or via RRC signaling. In some aspects, the reference transmit power may be a most recently indicated downlink transmit power (such as via the configuration). In some aspects, the reference transmit power may be explicitly indicated to the wireless communication device (such as via the configuration or separately from the configuration). These techniques can also be performed when calculating per-cell metrics, which may be determined using multiple Layer 1 measurements (such as on different beams). Thus, accuracy of Layer 1 measurement may be improved in cases where transmit power of an SSB can be adjusted from transmission to transmission.

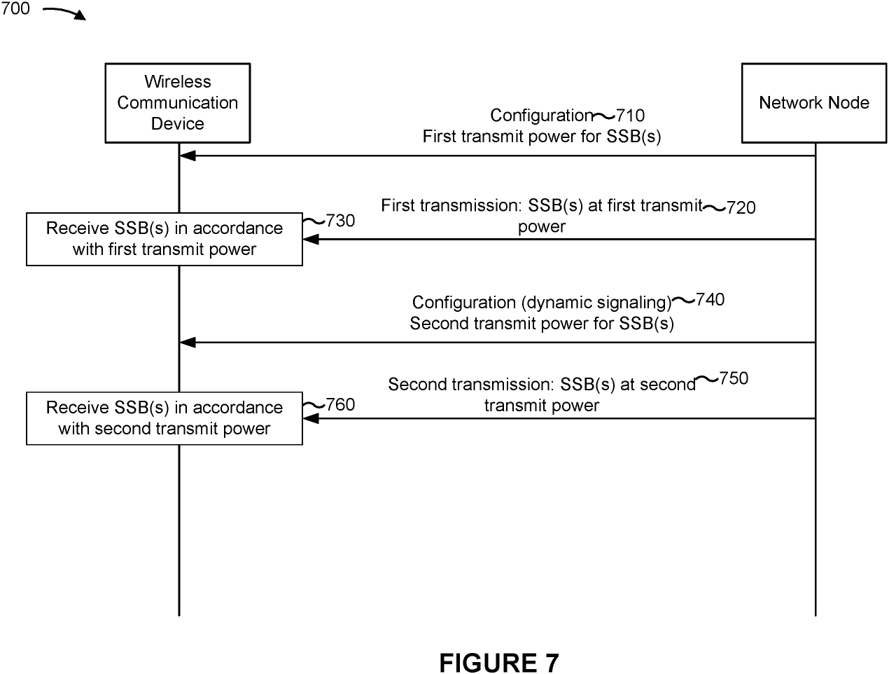

FIG. 7 is a diagram illustrating an example 700 of dynamic signaling providing adjustment of SSB transmit power. As shown, the example 700 includes a network node and a wireless communication device. The network node may include, for example, a base station 110, an IAB node (such as the anchor base station 335, the non-anchor base station 345, the IAB donor 405, or the IAB node 410), a DU function of an IAB node, or an O-RAN DU. The wireless communication device may include, for example, a UE 120 or a UE 355, a base station 110, an IAB node (such as the non-anchor base station 345 or the IAB node 410), an MT function of an IAB node, or an O-RAN MT.

The example 700 shows dynamic signaling in order to adjust a downlink transmit power of an SSB. In the example 700, the dynamic signaling is shown as occurring between two SSB transmissions, where a first transmission of the SSB occurs after configuration of a first downlink transmit power for the SSB. In some aspects, the dynamic signaling may occur before the first transmission of the SSB. For example, the network node may configure the first transmit power, and may transmit dynamic signaling indicating a second downlink transmit power before the first transmission. In other words, the dynamic signaling is shown between the first transmission and the second transmission, but can occur at any time.

As shown by reference number 710, the network node may transmit a configuration. The configuration may indicate a first downlink transmit power for a set of SSBs. In some aspects, the configuration may include at least part of the information described in connection with reference number 620 and 630 of FIG. 6. For example, the configuration may indicate a downlink transmit power using any of the techniques described with regard to FIG. 6. In some aspects, the configuration may indicate multiple downlink transmit powers, of which one or more may be adjusted via dynamic signaling. In some aspects, the configuration shown by reference number 710 may be transmitted via system information, such as SIB 1.

In some aspects, the configuration may relate to one or more resources, as described in connection with FIG. 6. In some aspects, the configuration may relate to one or more signals or types of signals, as described in connection with FIG. 6. In some aspects, the configuration may relate to a communication with a set of parameters, as described in connection with FIG. 6. In some aspects, the configuration may be based on a request from a wireless communication device, as described in connection with FIG. 6.

As shown by reference number 720, the network node may transmit the set of SSBs using the first transmit power. As shown by reference number 730, the wireless communication device may receive the set of SSBs in accordance with the first transmit power. For example, the wireless communication device may perform one or more operations described with regard to FIG. 6 in accordance with the first transmit power.

As shown by reference number 740, the network node may transmit a configuration via dynamic signaling (which is referred to hereafter as “the dynamic signaling”). The dynamic signaling may indicate a second downlink transmit power for the set of SSBs. In some aspects, the dynamic signaling may indicate the second downlink transmit power using an absolute value. In some other aspects, the dynamic signaling may indicate the second transmit power using an offset (such as relative to the first downlink transmit power or a different downlink transmit power). In some other aspects, the dynamic signaling may indicate an index associated with one or more of a set of configured downlink transmit power values. For example, the set of configured downlink transmit power values may be configured via RRC signaling. By indicating the configuration via dynamic signaling, the network node may reduce overhead and delay associated with updating the downlink transmit power of the set of SSBs relative to updating SIB1.

In some aspects, the dynamic signaling may include DCI or MAC signaling (such as a MAC control element (MAC-CE)). In some aspects, the DCI may be a short message, such as an extended short message. A short message is a message carried in DCI scrambled by a paging radio network temporary identifier (P-RNTI). The short message may indicate a system information update or may schedule a PDSCH that carries a paging message. In some aspects, the extended short message may indicate the second downlink transmit power (such as in one or more reserved bits of a DCI format of DCI carrying the short message). In some aspects, the extended short message may schedule a PDSCH, and the PDSCH may include the configuration indicating the second downlink transmit power. In some aspects, the DCI may be a group common DCI. In some aspects, the DCI may have a DCI format associated with downlink transmit power control. For example, the DCI may be scrambled by a RNTI specific to DCI carrying downlink transmit power control information (such as an indication of a downlink transmit power). In some aspects, the dynamic signaling may be provided via a MAC-CE, such as in a dedicated manner.

As shown by reference number 750, the network node may transmit the set of SSBs using the second downlink transmit power. As shown by reference number 760, the wireless communication device may receive the set of SSBs in accordance with the second downlink transmit power. For example, the wireless communication device may receive or process the set of SSBs as described in connection with FIG. 6. In some aspects, the wireless communication device may apply the second downlink transmit power based on a timeline. In some aspects, the timeline may be configured, such as by the network node, separately from the dynamic signaling. In some aspects, the timeline may be configured as part of the configuration shown by reference number 710. In some aspects, the dynamic signaling may indicate the configuration. In some aspects, the configuration may indicate a minimum timeline for applying the second downlink transmit power. Additionally, or alternatively, the configuration may indicate a maximum timeline for applying the second downlink transmit power.

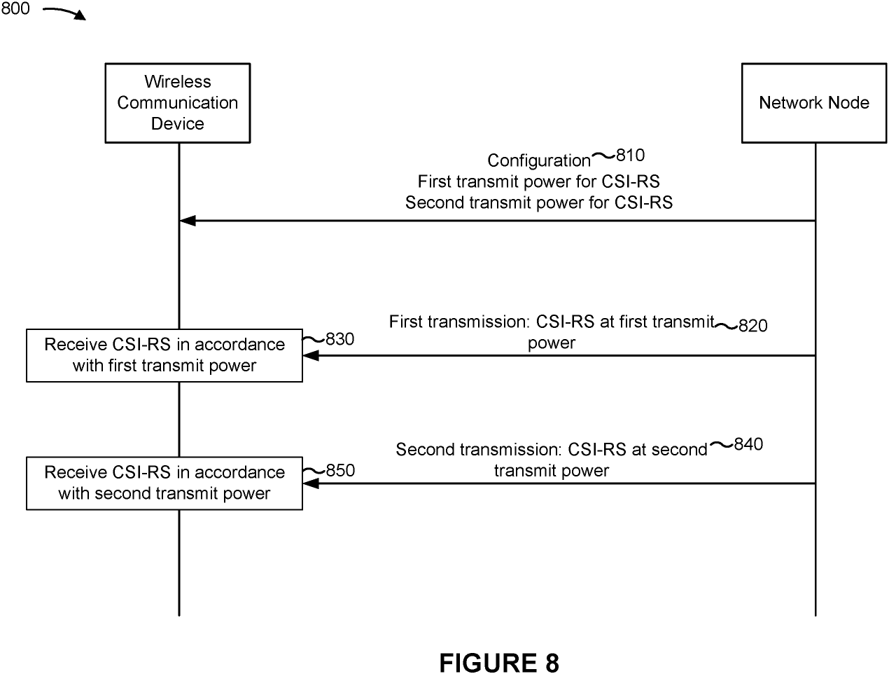

FIG. 8 is a diagram illustrating an example 800 of a semi-static configuration providing variable CSI-RS transmit power. As shown, example 800 includes a network node and a wireless communication device. The network node may include, for example, a base station 110, an IAB node (such as the anchor base station 335, the non-anchor base station 345, the IAB donor 405, or the IAB node 410), a DU function of an IAB node, or an O-RAN DU. The wireless communication device may include, for example, a UE 120 or a UE 355, a base station 110, an IAB node (such as the non-anchor base station 345 or the IAB node 410), an MT function of an IAB node, or an O-RAN MT.

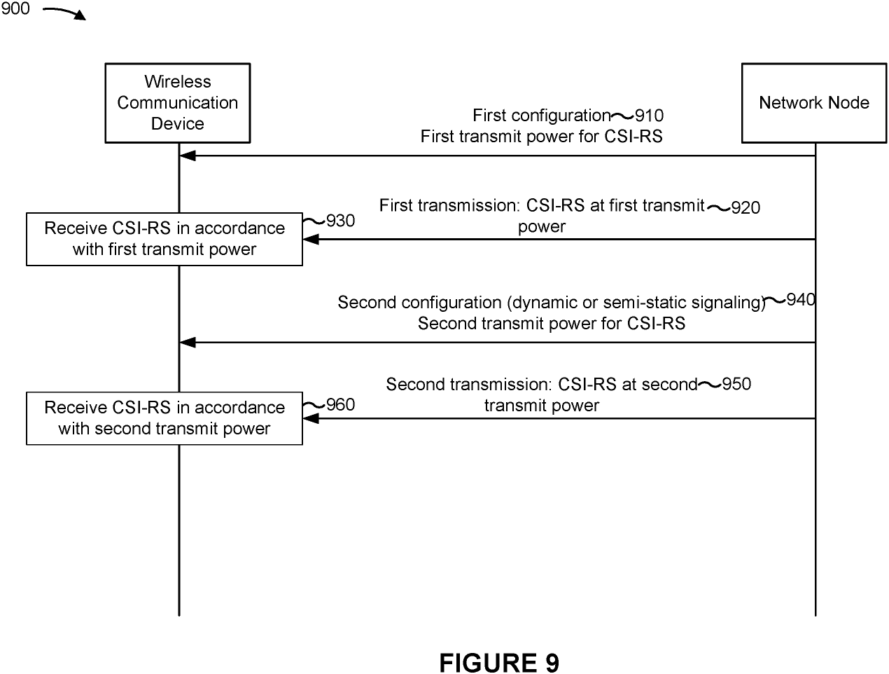

As shown by reference number 810, the network node may transmit a configuration. For example, the configuration may be transmitted via RRC signaling. The configuration may indicate a first downlink transmit power for a CSI-RS and a second downlink transmit power for the CSI-RS. For example, the configuration may include configuration information for a non-zero power CSI-RS resource (NZP-CSI-RS resource), such as a configuration NZP-CSI-RS-Resource, referred to herein as a CSI-RS configuration. The configuration information may indicate multiple downlink transmit powers for the NZP-CSI-RS resource. In some aspects, the configuration information may include multiple indications of an absolute downlink transmit power (such as multiple values of a parameter powerControlOffsetSS, referred to herein as a power control offset parameter). In this context, an indication of an absolute transmit power may indicate a particular value of powerControlOffsetSS, which defines an offset relative to an SSS. In some aspects, an indication of an absolute downlink transmit power may indicate a value from a range of values, for example, including -6 dB, -9 dB, or another value. In some other aspects, the configuration information may include one or more offsets relative to a reference transmit power. For example, the configuration information may indicate an offset relative to a downlink transmit power of a CSI-RS. In some aspects, the network node may transmit signaling (such as dynamic or semi-static signaling) to indicate a selected downlink transmit power of the multiple downlink transmit powers indicated by the configuration, as described in connection with FIG. 9.

In some aspects, the configuration may indicate a downlink transmit power based on a mode of operation of the network node or the wireless communication device. For example, a first CSI-RS (configured with a first transmit power) may be associated with a first mode of operation, and a second CSI-RS (configured with a second transmit power) may be associated with a second mode of operation. As some examples, a mode of operation can include a multiplexing mode, such as a half-duplex mode, a full-duplex mode, an MT-transmit and DU-transmit mode in IAB, or an MT-receive and DU-transmit mode in IAB.

In some aspects, the configuration may indicate a downlink transmit power based on a type of resources. For example, the configuration may indicate that CSI-RSs associated with a downlink resource are associated with a first downlink transmit power, CSI-RSs associated with a flexible resource are associated with a second downlink transmit power, and CSI-RSs associated with a full-duplex resource are associated with a third downlink transmit power. Additionally, or alternatively, the configuration may indicate that CSI-RSs associated with a hard resource are associated with a first downlink transmit power, CSI-RSs associated with a soft resource are associated with a second downlink transmit power, and CSI-RSs associated with a non-available resource are associated with a third downlink transmit power.

In some aspects, the configuration may relate to one or more resources, as described in connection with FIG. 6. In some aspects, the configuration may relate to one or more signals or types of signals, as described in connection with FIG. 6. In some aspects, the configuration may relate to a communication with a set of parameters, as described in connection with FIG. 6. In some aspects, the configuration may be based on a request from a wireless communication device, as described in connection with FIG. 6.

As shown by reference number 820, the network node may transmit a set of CSI-RSs using the first downlink transmit power. As shown by reference number 830, the wireless communication device may receive the set of CSI-RSs in accordance with the first downlink transmit power. As shown by reference number 840, the network node may transmit the set of CSI-RSs using the second downlink transmit power. As shown by reference number 850, the wireless communication device may receive the set of CSI-RSs in accordance with the second downlink transmit power. For example, the wireless communication device may determine CSI in accordance with the first downlink transmit power or the second transmit power. As another example, the wireless communication device may determine a transmit power for a PDSCH or another signal in accordance with the first downlink transmit power or the second downlink transmit power. As yet another example, the wireless communication device may perform a channel measurement on the set of CSI-RSs based on the first downlink transmit power or the second downlink transmit power.

In some aspects, the wireless communication device may perform a Layer 1 measurement on a CSI-RS. A Layer 1 measurement on a CSI-RS may include, for example, a CSI-RSRP, a CSI-RSRQ, or a CSI-SINR. The wireless communication device may normalize a Layer 1 measurement on a CSI-RS based on a downlink transmit power associated with the CSI-RS. For example, the wireless communication device may apply a scaling factor to the Layer 1 measurement so that the downlink transmit power associated with the CSI-RS is accounted for. In some aspects, the configuration may indicate the scaling factor. In some other aspects, the wireless communication device may determine the scaling factor based on a downlink transmit power indicated by the configuration. For example, the wireless communication device may determine the scaling factor based on at least one of the downlink transmit power used to transmit the CSI-RS and a reference transmit power. In some aspects, the reference transmit power may be an original transmit power configured in SIB 1 or via RRC signaling. In some aspects, the reference transmit power may be a most recently indicated downlink transmit power (such as via the configuration). In some aspects, the reference transmit power may be explicitly indicated to the wireless communication device (such as via the configuration or separately from the configuration). These techniques can also be performed when calculating per-cell metrics, which may be determined using multiple Layer 1 measurements (such as on different beams). Thus, accuracy of Layer 1 measurement may be improved in cases where transmit power of a CSI-RS can be adjusted from transmission-to-transmission.

FIG. 9 is a diagram illustrating an example 900 of signaling supporting adjustment of CSI-RS transmit power. As shown, example 900 includes a network node and a wireless communication device. The network node may include, for example, a base station 110, an IAB node (such as the anchor base station 335, the non-anchor base station 345, the IAB donor 405, or the IAB node 410), a DU function of an IAB node, or an O-RAN DU. The wireless communication device may include, for example, a UE 120 or a UE 355, a base station 110, an IAB node (such as the non-anchor base station 345 or the IAB node 410), an MT function of an IAB node, or an O-RAN MT.

The example 900 shows signaling in order to adjust a downlink transmit power of a CSI-RS. In the example 900, the signaling is shown as occurring between two CSI-RS transmissions, where a first transmission of the CSI-RS occurs after configuration of a first downlink transmit power for the CSI-RS. In some aspects, the signaling may occur before the first transmission of the CSI-RS. For example, the network node may configure the first transmit power, and may transmit signaling indicating a second downlink transmit power before the first transmission. In other words, the signaling is shown between the first transmission and the second transmission, but can occur at any time.

As shown by reference number 910, the network node may transmit a first configuration. The first configuration may indicate one or more of a first downlink transmit power or a second downlink transmit power for a CSI-RS. In some aspects, the first configuration may indicate only the first downlink transmit power. In some other aspects, the first configuration may indicate the first downlink transmit power and the second downlink transmit power. For example, the first configuration may indicate multiple downlink transmit powers. Subsequent signaling (such as the signaling shown by reference number 940) may select one of the multiple downlink transmit powers for a CSI-RS. In some aspects, the first configuration may include at least part of the information included in the configuration shown by reference number 810 of FIG. 8. For example, the first configuration may include a configuration of an NZP-CSI-RS resource.

In some aspects, the configuration may relate to one or more resources, as described in connection with FIG. 6. In some aspects, the configuration may relate to one or more signals or types of signals, as described in connection with FIG. 6. In some aspects, the configuration may relate to a communication with a set of parameters, as described in connection with FIG. 6. In some aspects, the configuration may be based on a request from a wireless communication device, as described in connection with FIG. 6.

As shown by reference number 920, the network node may transmit a CSI-RS using the first downlink transmit power. As shown by reference number 930, the wireless communication device may receive the CSI-RS in accordance with the first downlink transmit power, as described in more detail, for example, in connection with reference numbers 830 and 850 of FIG. 8.

As shown by reference number 940, the network node may transmit a second configuration. In some aspects, the second configuration may be transmitted using dynamic signaling, such as DCI, group-common DCI, a downlink transmit power control command, a MAC-CE, or a broadcast indication. In some other aspects, the second configuration may be transmitted using semi-static signaling, such as RRC configuration. For example, the second configuration may indicate an updated downlink transmit power (such as a value of powerControlOffsetSS). In some aspects, the second configuration may indicate an updated downlink transmit power without reconfiguring one or more other parameters. For example, the second configuration may indicate an updated value of powerControlOffsetSS (such as explicitly, or based on an indication of one of multiple configured values of powerControlOffsetSS) without updating other parameters of a configuration of an NZP-CSI-RS resource.

As shown by reference number 950, the network node may transmit the CSI-RS using the second downlink transmit power. As shown by reference number 960, the wireless communication device may receive the CSI-RS in accordance with the second downlink transmit power, as described in more detail, for example, in connection with reference numbers 830 and 850 of FIG. 8.

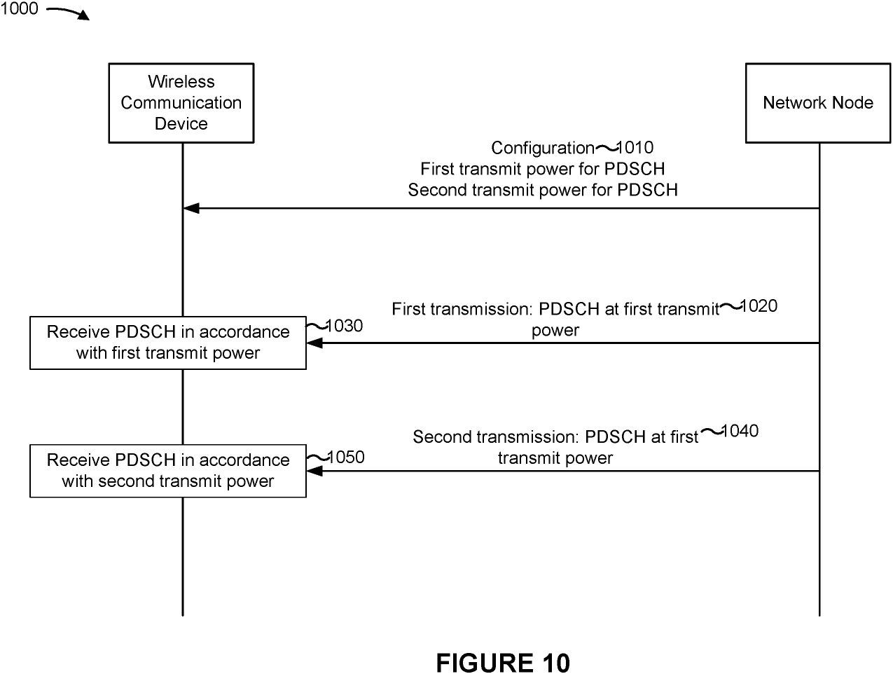

FIG. 10 is a diagram illustrating an example 1000 of a semi-static configuration providing variable SSB transmit power. As shown, example 1000 includes a network node and a wireless communication device. The network node may include, for example, a base station 110, an IAB node (such as the anchor base station 335, the non-anchor base station 345, the IAB donor 405, or the IAB node 410), a DU function of an IAB node, or an O-RAN DU. The wireless communication device may include, for example, a UE 120 or a UE 355, a base station 110, an IAB node (such as the non-anchor base station 345 or the IAB node 410), an MT function of an IAB node, or an O-RAN MT.

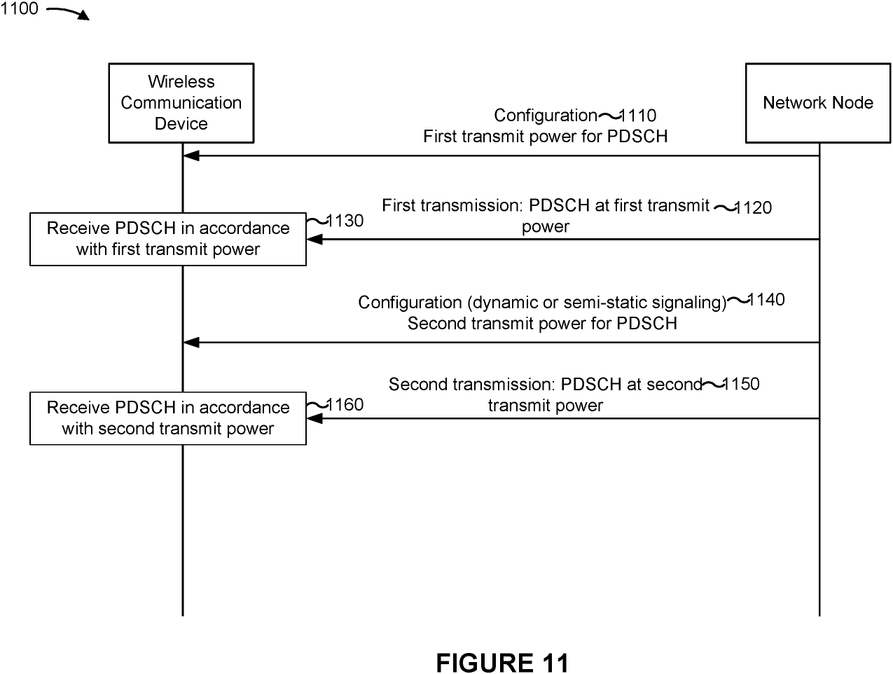

As shown by reference number 1010, the network node may transmit a configuration indicating a first downlink transmit power and a second downlink transmit power. The first downlink transmit power may be for a first PDSCH, and the second downlink transmit power may be for a second PDSCH. In some aspects, the configuration may indicate multiple downlink transmit powers, and multiple downlink transmit powers may be used to dynamically modify a downlink transmit power of the PDSCH (such as based on a dynamic indication), as described in connection with FIG. 11.

In some aspects, the configuration may indicate multiple downlink transmit powers based on an NZP-CSI-RS resource. For example, a PDSCH’s downlink transmit power may be defined by a parameter powerControlOffset of an NZP-CSI-RS resource configuration indicating an offset relative to a CSI-RS associated with the NZP-CSI-RS resource. The configuration shown by reference number 1010 may include multiple values of the parameter powerControlOffset for a given NZP-CSI-RS resource, corresponding to multiple downlink transmit powers. In some aspects, the multiple downlink transmit powers may be associated with different periods (as described in connection with the SSB, in connection with FIGS. 6 and 7), different modes of operation (such as different multiplexing modes), or different resources or types of resources. In some aspects, the multiple downlink transmit powers may be used to dynamically modify a downlink transmit power of the PDSCH, as described in connection with FIG. 11.

In some aspects, the configuration may indicate multiple downlink transmit powers based on a bandwidth part (BWP) configuration. A BWP configuration may include a PDSCH configuration which may indicate various parameters associated with a PDSCH transmitted in a BWP associated with the BWP configuration. In some aspects, the PDSCH configuration may include information indicating multiple downlink transmit powers. For example, the PDSCH configuration may include information indicating multiple absolute downlink transmit powers. As another example, the PDSCH configuration may include information indicating one or more offsets used to determine one or more downlink transmit powers. In some aspects, the BWP configuration may indicate multiple downlink transmit powers (such as separately from the PDSCH configuration). For example, the BWP configuration may include information indicating multiple absolute downlink transmit powers. As another example, the BWP configuration may include information indicating one or more offsets used to determine one or more downlink transmit powers. In some aspects, the multiple downlink transmit powers may be used to dynamically modify a downlink transmit power of the PDSCH, as described in connection with FIG. 11.

As shown by reference number 1020, the network node may transmit a first PDSCH using the first downlink transmit power. As shown by reference number 1030, the wireless communication device may receive the first PDSCH in accordance with the first downlink transmit power. As shown by reference number 1040, the network node may transmit a second PDSCH using the second downlink transmit power. As shown by reference number 1050, the wireless communication device may receive the PDSCH in accordance with the second downlink transmit power. For example, the wireless communication device may determine the first downlink transmit power or the second downlink transmit power based on the parameter powerControlOffset and a received CSI-RS’s EPRE. The wireless communication device may receive the first PDSCH in accordance with the first downlink transmit power and the second PDSCH in accordance with the second downlink transmit power.

In some aspects, the configuration may relate to one or more resources, as described in connection with FIG. 6. In some aspects, the configuration may relate to one or more signals or types of signals, as described in connection with FIG. 6. In some aspects, the configuration may relate to a communication with a set of parameters, as described in connection with FIG. 6. In some aspects, the configuration may be based on a request from a wireless communication device, as described in connection with FIG. 6.

FIG. 11 is a diagram illustrating an example 1100 of signaling supporting adjustment of PDSCH transmit power. As shown, example 1100 includes a network node and a wireless communication device. The network node may include, for example, a base station 110, an IAB node (such as the anchor base station 335, the non-anchor base station 345, the IAB donor 405, or the IAB node 410), a DU function of an IAB node, or an O-RAN DU. The wireless communication device may include, for example, a UE 120 or a UE 355, a base station 110, an IAB node (such as the non-anchor base station 345 or the IAB node 410), an MT function of an IAB node, or an O-RAN MT.

The example 1100 shows signaling in order to adjust a downlink transmit power of a PDSCH. In the example 1100, the signaling is shown as occurring between two PDSCH transmissions, where a first transmission of the PDSCH occurs after configuration of a first downlink transmit power for the PDSCH. In some aspects, the signaling may occur before the first transmission of the PDSCH. For example, the network node may configure the first transmit power, and may transmit signaling indicating a second downlink transmit power before the first transmission. In other words, the signaling is shown between the first transmission and the second transmission, but can occur at any time prior to the second transmission.

As shown by reference number 1110, the network node may transmit a first configuration. The first configuration may indicate one or more of a first downlink transmit power or a second downlink transmit power for a PDSCH. In some aspects, the first configuration may indicate only the first downlink transmit power. In some other aspects, the first configuration may indicate the first downlink transmit power and the second downlink transmit power. For example, the first configuration may indicate multiple downlink transmit powers. Subsequent signaling (such as the signaling shown by reference number 1140) may select one of the multiple downlink transmit powers for a PDSCH. In some aspects, the first configuration may include at least part of the information included in the configuration shown by reference number 1010 of FIG. 10. For example, the first configuration may include a BWP configuration, a PDSCH configuration of a BWP configuration, or a configuration of an NZP-CSI-RS resource.

In some aspects, the configuration may relate to one or more resources, as described in connection with FIG. 6. In some aspects, the configuration may relate to one or more signals or types of signals, as described in connection with FIG. 6. In some aspects, the configuration may relate to a communication with a set of parameters, as described in connection with FIG. 6. In some aspects, the configuration may be based on a request from a wireless communication device, as described in connection with FIG. 6.

As shown by reference number 1120, the network node may transmit a first PDSCH using the first downlink transmit power. As shown by reference number 1130, the wireless communication device may receive the PDSCH in accordance with the first downlink transmit power, as described in more detail, for example, in connection with reference numbers 1030 and 1050 of FIG. 10.

As shown by reference number 1140, the network node may transmit a second configuration. In some aspects, the second configuration may be transmitted using dynamic signaling, such as DCI, group-common DCI, scheduling DCI, a downlink transmit power control command, a MAC-CE, or a broadcast indication. In some other aspects, the second configuration may be transmitted using semi-static signaling, such as RRC configuration. For example, the second configuration may indicate an updated downlink transmit power (such as a value of powerControlOffsetSS) for an NZP-CSI-RS resource, such that the corresponding CSI-RS's transmit power is modified. Since the downlink transmit power of the PDSCH is derived from the CSI-RS's downlink transmit power, the downlink transmit power of the PDSCH is modified. In some aspects, the second configuration may indicate an updated downlink transmit power without reconfiguring one or more other parameters. For example, the second configuration may indicate an updated value of powerControlOffsetSS (such as explicitly, or based on an indication of one of multiple configured values of powerControlOffsetSs) without updating other parameters of a configuration of an NZP-CSI-RS resource (such as a parameter powerControlOffset). As another example, the second configuration may indicate an updated value of powerControlOffset (such as explicitly, or based on an indication of one of multiple configured values of powerControlOffset) without updating other parameters of a configuration of an NZP-CSI-RS resource (such as a parameter powerControlOffsetSS).

In some aspects, the second configuration may indicate a selected downlink transmit power of multiple configured downlink transmit powers. For example, the first configuration may configure multiple downlink transmit powers, such as multiple powerControlOffset parameters, multiple PDSCH configuration parameters, or multiple BWP configuration parameters. The second configuration may indicate a selected one of the multiple downlink transmit powers, such as based on an index associated with the selected downlink transmit power. As another example, the second configuration may implicitly indicate the selected downlink transmit power, such as based on a resource used to transmit the second configuration, a format used for the second configuration, a radio network temporary identifier used for the second configuration, or another indication.

As shown by reference number 1150, the network node may transmit the PDSCH using the second downlink transmit power. As shown by reference number 1160, the wireless communication device may receive the PDSCH in accordance with the second downlink transmit power, as described in more detail, for example, in connection with reference numbers 1030 and 1050 of FIG. 10.

FIG. 12 is a diagram illustrating an example process 1200 performed, for example, by a network node. The process 1200 is an example where the network node (for example, a base station 110, an IAB node (such as the anchor base station 335, the non-anchor base station 345, the IAB donor 405, or the IAB node 410), a DU function of an IAB node, or an O-RAN DU) performs operations associated with downlink transmit power adjustment.

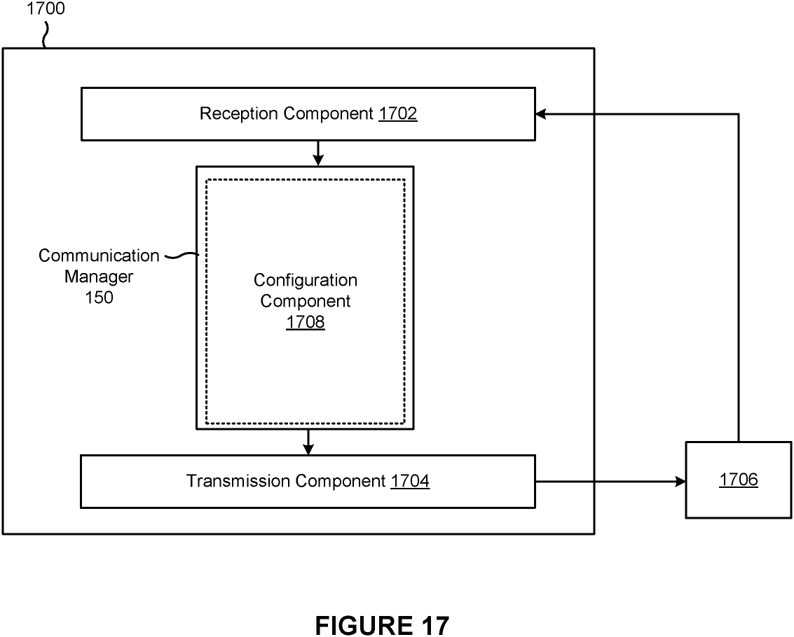

As shown in FIG. 12, in some aspects, the process 1200 may include transmitting a configuration that indicates a first transmit power associated with a first transmission of a downlink reference signal and a second transmit power associated with a second transmission of the downlink reference signal, where the first transmit power is different than the second transmit power (block 1210). For example, the network node (such as by using communication manager 150 or transmission component 1704, depicted in FIG. 17) may output (e.g., transmit or provide for transmission) a configuration that indicates a first transmit power associated with a first transmission of a downlink reference signal and a second transmit power associated with a second transmission of the downlink reference signal, where the first transmit power is different than the second transmit power. In some aspects, the configuration may be transmitted by another node, such as a CU. In such aspects, the process 1200 may not include transmitting the configuration.

As further shown in FIG. 12, in some aspects, the process 1200 may include transmitting the first transmission of the downlink reference signal in accordance with the first transmit power (block 1220). For example, the network node (such as by using communication manager 150 or transmission component 1704, depicted in FIG. 17) may output (e.g., transmit or provide for transmission) the first transmission of the downlink reference signal in accordance with the first transmit power.

As further shown in FIG. 12, in some aspects, the process 1200 may include transmitting the second transmission of the downlink reference signal in accordance with the second transmit power (block 1230). For example, the network node (such as by using communication manager 150 or transmission component 1704, depicted in FIG. 17) may output (e.g., transmit or provide for transmission) the second transmission of the downlink reference signal in accordance with the second transmit power.

The process 1200 may include additional aspects, such as any single aspect or any combination of aspects described in connection with the process 1200 or in connection with one or more other processes described elsewhere herein.

In a first additional aspect, the first transmission and the second transmission are transmissions of a synchronization signal block burst set including the downlink reference signal.

In a second additional aspect, alone or in combination with the first aspect, the first transmission is associated with one of initial access, radio resource management, or inter-node discovery, and where the second transmission is associated with a different one of initial access, radio resource management, or inter-node discovery than the first transmission.

In a third additional aspect, alone or in combination with one or more of the first and second aspects, the first transmission and the second transmission are associated with a periodic configuration, and where the first transmit power is used for a first subset of transmission occasions of the periodic configuration and the second transmit power is used for a second subset of transmission occasions of the periodic configuration.

In a fourth additional aspect, alone or in combination with one or more of the first through third aspects, the first transmit power is associated with the first transmission based at least in part on at least one of a bitmap, an offset, a periodicity, a center frequency associated with the first transmission of the downlink reference signal, or a multiplexing mode associated with the first transmission.

In a fifth additional aspect, alone or in combination with one or more of the first through fourth aspects, the configuration is included in a SMTC for a cell or group of cells on which the downlink reference signal is transmitted.

In a sixth additional aspect, alone or in combination with one or more of the first through fifth aspects, the configuration indicates an index that identifies the first transmit power or the second transmit power based at least in part on a configured set of transmit powers.

In a seventh additional aspect, alone or in combination with one or more of the first through sixth aspects, the configuration is transmitted via DCI, a shared channel scheduled by DCI, or MAC signaling.

In an eighth additional aspect, alone or in combination with one or more of the first through seventh aspects, the DCI uses a DCI format associated with downlink transmit power control.

In a ninth additional aspect, alone or in combination with one or more of the first through eighth aspects, transmitting the first transmission or transmitting the second transmission is based at least in part on at least one of a configured timeline for applying the configuration, or a timeline, indicated by the configuration, for applying the configuration.

In a tenth additional aspect, alone or in combination with one or more of the first through ninth aspects, the configuration includes a first SMTC that indicates the first transmit power and a second SMTC that indicates the second transmit power.

In an eleventh additional aspect, alone or in combination with one or more of the first through tenth aspects, the configuration is included in a STC.

In a twelfth additional aspect, alone or in combination with one or more of the first through eleventh aspects, the process 1200 includes receiving the STC from a central unit.

In a thirteenth additional aspect, alone or in combination with one or more of the first through twelfth aspects, the process 1200 includes transmitting the STC to a central unit.

In a fourteenth additional aspect, alone or in combination with one or more of the first through thirteenth aspects, the first transmit power or the second transmit power is associated with a particular STC.

In a fifteenth additional aspect, alone or in combination with one or more of the first through fourteenth aspects, the first transmit power or the second transmit power is associated with all STCs associated with the network node.

In a sixteenth additional aspect, alone or in combination with one or more of the first through fifteenth aspects, the configuration indicates a scaling factor for measurements associated with the downlink reference signal.

In a seventeenth additional aspect, alone or in combination with one or more of the first through sixteenth aspects, the configuration indicates a reference transmit power.

In an eighteenth additional aspect, alone or in combination with one or more of the first through seventeenth aspects, the configuration indicates an offset between a transmit power of a PBCH of the downlink reference signal and a transmit power of a synchronization signal of the downlink reference signal.

In a nineteenth additional aspect, alone or in combination with one or more of the first through eighteenth aspects, the configuration indicates an offset between a transmit power of a PSS of the downlink reference signal and a transmit power of a SSS of the downlink reference signal.

In a twentieth additional aspect, alone or in combination with one or more of the first through nineteenth aspects, the configuration indicates the first transmit power and the second transmit power for a channel state information reference signal resource.

In a twenty-first additional aspect, alone or in combination with one or more of the first through twentieth aspects, the first transmit power is associated with a first multiplexing mode of the first transmission and the second transmit power is associated with a second multiplexing mode of the second transmission.

In a twenty-second additional aspect, alone or in combination with one or more of the first through twenty-first aspects, the first transmit power is associated with a first resource type and the second transmit power is associated with a second resource type.

In a twenty-third additional aspect, alone or in combination with one or more of the first through twenty-second aspects, the configuration indicates the first transmit power or the second transmit power as a power control offset parameter of a channel state information reference signal configuration, and where a remainder of the channel state information reference signal configuration is unmodified by the configuration.

In a twenty-fourth additional aspect, alone or in combination with one or more of the first through twenty-third aspects, the configuration is transmitted via one of a downlink transmit power control command or broadcast signaling.

Although FIG. 12 shows example blocks of the process 1200, in some aspects, the process 1200 may include additional blocks, fewer blocks, different blocks, or differently arranged blocks than those depicted in FIG. 12. Additionally, or alternatively, two or more of the blocks of the process 1200 may be performed in parallel.

FIG. 13 is a diagram illustrating an example process 1300 performed, for example, by a network node. The process 1300 is an example where the network node (for example, a base station 110, an IAB node (such as the anchor base station 335, the non-anchor base station 345, the IAB donor 405, or the IAB node 410), a DU function of an IAB node, or an O-RAN DU) performs operations associated with downlink transmit power adjustment.

As shown in FIG. 13, in some aspects, the process 1300 may include transmitting a configuration that indicates a first transmit power associated with a first PDSCH and a second transmit power associated with a second PDSCH, where the first transmit power is different than the second transmit power (block 1310). For example, the network node (such as by using communication manager 150 or transmission component 1704, depicted in FIG. 17) may output (e.g., transmit or provide for transmission) a configuration that indicates a first transmit power associated with a first PDSCH and a second transmit power associated with a second PDSCH, where the first transmit power is different than the second transmit power.

As further shown in FIG. 13, in some aspects, the process 1300 may include transmitting the first PDSCH in accordance with the first transmit power (block 1320). For example, the network node (such as by using communication manager 150 or transmission component 1704, depicted in FIG. 17) may output (e.g., transmit or provide for transmission) the first PDSCH in accordance with the first transmit power.

As further shown in FIG. 13, in some aspects, the process 1300 may include transmitting the second PDSCH in accordance with the second transmit power (block 1330). For example, the network node (such as by using communication manager 150 or transmission component 1704, depicted in FIG. 17) may output (e.g., transmit or provide for transmission) the second PDSCH in accordance with the second transmit power.

The process 1300 may include additional aspects, such as any single aspect or any combination of aspects described in connection with the process 1300 or in connection with one or more other processes described elsewhere herein.

In a first additional aspect, the configuration indicates the first transmit power or the second transmit power based at least in part on updating a power control offset parameter of a CSI-RS configuration, where the power control offset parameter is between a CSI-RS and a synchronization signal or between a CSI-RS and a PDSCH.

In a second additional aspect, alone or in combination with the first aspect, the configuration is transmitted via at least one of downlinking control information, or a downlink transmit power control command carried via downlink control information.

In a third additional aspect, alone or in combination with one or more of the first and second aspects, the configuration is transmitted via medium access control signaling.

In a fourth additional aspect, alone or in combination with one or more of the first through third aspects, the first transmit power is associated with a first power control offset parameter of a CSI-RS configuration and the second transmit power is associated with a second power control offset parameter of the CSI-RS configuration.

In a fifth additional aspect, alone or in combination with one or more of the first through fourth aspects, the first transmit power is associated with a first periodicity and the second transmit power is associated with a second periodicity.

In a sixth additional aspect, alone or in combination with one or more of the first through fifth aspects, the first transmit power is associated with a first multiplexing mode and the second transmit power is associated with a second multiplexing mode.

In a seventh additional aspect, alone or in combination with one or more of the first through sixth aspects, the first transmit power is associated with a first resource type and the second transmit power is associated with a second resource type.

In an eighth additional aspect, alone or in combination with one or more of the first through seventh aspects, the configuration is a downlink bandwidth part configuration.

Although FIG. 13 shows example blocks of the process 1300, in some aspects, the process 1300 may include additional blocks, fewer blocks, different blocks, or differently arranged blocks than those depicted in FIG. 13. Additionally, or alternatively, two or more of the blocks of the process 1300 may be performed in parallel.

FIG. 14 is a diagram illustrating an example process 1400 performed, for example, by a wireless communication device. The process 1400 is an example where the wireless communication device (for example, a UE 120 or a UE 355, a base station 110, an IAB node (such as the non-anchor base station 345 or the IAB node 410), an MT function of an IAB node, or an O-RAN MT) performs operations associated with downlink transmit power adjustment.

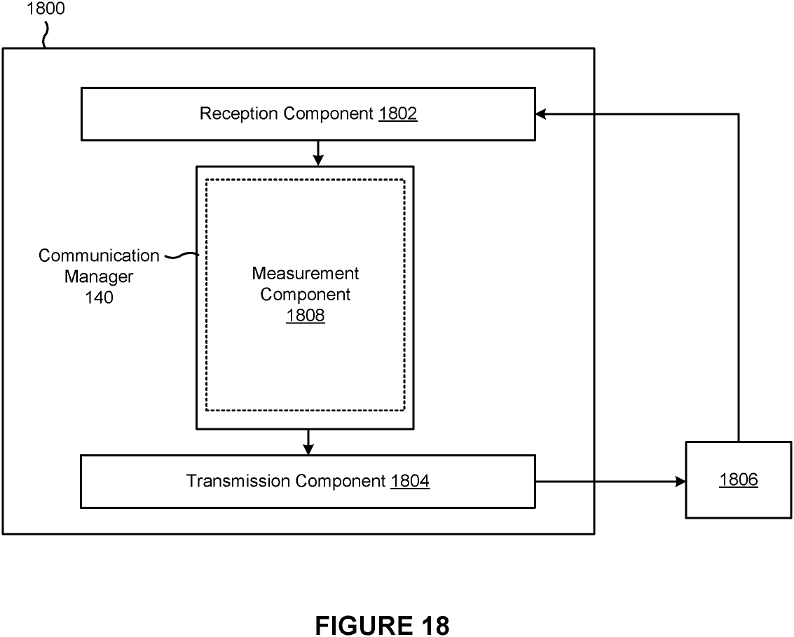

As shown in FIG. 14, in some aspects, the process 1400 may include receiving a configuration that indicates a first transmit power associated with a first transmission of a downlink reference signal and a second transmit power associated with a second transmission of the downlink reference signal, where the first transmit power is different than the second transmit power (block 1410). For example, the wireless communication device (such as by using communication manager 140 or reception component 1802, depicted in FIG. 18) may receive a configuration that indicates a first transmit power associated with a first transmission of a downlink reference signal and a second transmit power associated with a second transmission of the downlink reference signal, where the first transmit power is different than the second transmit power.

As further shown in FIG. 14, in some aspects, the process 1400 may include receiving the first transmission of the downlink reference signal in accordance with the first transmit power (block 1420). For example, the wireless communication device (such as by using communication manager 140 or reception component 1802, depicted in FIG. 18) may receive the first transmission of the downlink reference signal in accordance with the first transmit power.

As further shown in FIG. 14, in some aspects, the process 1400 may include receiving the second transmission of the downlink reference signal in accordance with the second transmit power (block 1430). For example, the wireless communication device (such as by using communication manager 140 or reception component 1802, depicted in FIG. 18) may receive the second transmission of the downlink reference signal in accordance with the second transmit power.

The process 1400 may include additional aspects, such as any single aspect or any combination of aspects described in connection with the process 1400 or in connection with one or more other processes described elsewhere herein.

In a first additional aspect, the first transmission and the second transmission are transmissions of a synchronization signal block burst set including the downlink reference signal.

In a second additional aspect, alone or in combination with the first aspect, the first transmission and the second transmission are associated with a periodic configuration, and where the first transmit power is used for a first subset of transmission occasions of the periodic configuration and the second transmit power is used for a second subset of transmission occasions of the periodic configuration.

In a third additional aspect, alone or in combination with one or more of the first and second aspects, the configuration is included in a SMTC for a cell or group of cells on which the downlink reference signal is transmitted.

In a fourth additional aspect, alone or in combination with one or more of the first through third aspects, the configuration is received via DCI, a shared channel scheduled by DCI, or MAC signaling.

In a fifth additional aspect, alone or in combination with one or more of the first through fourth aspects, the DCI uses a DCI format associated with downlink transmit power control.

In a sixth additional aspect, alone or in combination with one or more of the first through fifth aspects, receiving the first transmission or receiving the second transmission is based at least in part on at least one of a configured timeline for applying the configuration, or a timeline, indicated by the configuration, for applying the configuration.

In a seventh additional aspect, alone or in combination with one or more of the first through sixth aspects, the configuration includes a first SMTC that indicates the first transmit power and a second SMTC that indicates the second transmit power.

In an eighth additional aspect, alone or in combination with one or more of the first through seventh aspects, the configuration is received via system information, and where the method further includes performing an RRM measurement on the downlink reference signal, and transmitting reporting information or triggering information based at least in part on scaling the RRM measurement in accordance with the configuration.

In a ninth additional aspect, alone or in combination with one or more of the first through eighth aspects, the configuration indicates a scaling factor for measurements associated with the downlink reference signal, and where the method further includes performing a measurement of the downlink reference signal using the scaling factor.

In a tenth additional aspect, alone or in combination with one or more of the first through ninth aspects, the configuration indicates a reference transmit power, and where the method further includes determining a scaling factor using the reference transmit power, and performing a measurement of the downlink reference signal using the scaling factor.

In an eleventh additional aspect, alone or in combination with one or more of the first through tenth aspects, the configuration indicates an offset between a transmit power of a PBCH of the downlink reference signal and a transmit power of a synchronization signal of the downlink reference signal.

In a twelfth additional aspect, alone or in combination with one or more of the first through eleventh aspects, the configuration indicates an offset between a transmit power of a PSS of the downlink reference signal and a transmit power of a SSS of the downlink reference signal.

In a thirteenth additional aspect, alone or in combination with one or more of the first through twelfth aspects, the configuration indicates the first transmit power or the second transmit power as a power control offset parameter of a channel state information reference signal configuration, and where a remainder of the channel state information reference signal configuration is unmodified by the configuration.

In a fourteenth additional aspect, alone or in combination with one or more of the first through thirteenth aspects, the configuration is received via one of a downlink transmit power control command or broadcast signaling.

Although FIG. 14 shows example blocks of the process 1400, in some aspects, the process 1400 may include additional blocks, fewer blocks, different blocks, or differently arranged blocks than those depicted in FIG. 14. Additionally, or alternatively, two or more of the blocks of the process 1400 may be performed in parallel.

FIG. 15 is a diagram illustrating an example process 1500 performed, for example, by a wireless communication device. The process 1500 is an example where the wireless communication device (for example, a UE 120 or a UE 355, a base station 110, an IAB node (such as the non-anchor base station 345 or the IAB node 410), an MT function of an IAB node, or an O-RAN MT) performs operations associated with downlink transmit power adjustment.

As shown in FIG. 15, in some aspects, the process 1500 may include receiving a configuration that indicates a first transmit power associated with a first PDSCH and a second transmit power associated with a second PDSCH, where the first transmit power is different than the second transmit power (block 1510). For example, the wireless communication device (such as by using communication manager 140 or reception component 1802, depicted in FIG. 18) may receive a configuration that indicates a first transmit power associated with a first PDSCH and a second transmit power associated with a second PDSCH, where the first transmit power is different than the second transmit power.

As further shown in FIG. 15, in some aspects, the process 1500 may include receiving the first PDSCH in accordance with the first transmit power (block 1520). For example, the wireless communication device (such as by using communication manager 140 or reception component 1802, depicted in FIG. 18) may receive the first PDSCH in accordance with the first transmit power.

As further shown in FIG. 15, in some aspects, the process 1500 may include receiving the second PDSCH in accordance with the second transmit power (block 1530). For example, the wireless communication device (such as by using communication manager 140 or reception component 1802, depicted in FIG. 18) may receive the second PDSCH in accordance with the second transmit power.

The process 1500 may include additional aspects, such as any single aspect or any combination of aspects described in connection with the process 1500 or in connection with one or more other processes described elsewhere herein.

In a first additional aspect, the configuration indicates the first transmit power or the second transmit power based at least in part on updating a power control offset parameter of a CSI-RS configuration, where the power control offset parameter is between a CSI-RS and a synchronization signal or between a CSI-RS and a PDSCH.

In a second additional aspect, alone or in combination with the first aspect, the first transmit power is associated with a first power control offset parameter of a CSI-RS configuration and the second transmit power is associated with a second power control offset parameter of the CSI-RS configuration.

In a third additional aspect, alone or in combination with one or more of the first and second aspects, the configuration is a downlink bandwidth part configuration.

Although FIG. 15 shows example blocks of the process 1500, in some aspects, the process 1500 may include additional blocks, fewer blocks, different blocks, or differently arranged blocks than those depicted in FIG. 15. Additionally, or alternatively, two or more of the blocks of the process 1500 may be performed in parallel.

FIG. 16 is a diagram illustrating an example process 1600 performed, for example, by a network node. The process 1600 is an example where the network node (for example, a base station 110, an IAB node (such as the anchor base station 335, the non-anchor base station 345, the IAB donor 405, or the IAB node 410), a DU function of an IAB node, or an O-RAN DU) performs operations associated with downlink transmit power adjustment.

As shown in FIG. 16, in some aspects, the process 1600 may include transmitting, in a STC or an SMTC, a configuration that indicates a transmit power for an SSB (block 1610). For example, the network node (such as by using communication manager 150 or transmission component 1704, depicted in FIG. 17) may output (e.g., transmit or provide for transmission), in a STC or an SMTC, a configuration that indicates a transmit power for an SSB. In some aspects, the STC or the SMTC may include an information element indicating the transmit power for the SSB. In some aspects, a wireless communication device may receive the configuration, and may perform reporting or may evaluate a triggering event based at least in part on the transmit power. In some aspects, the transmit power may be a static transmit power (such as, may not be updated by the configuration). In some other aspects, the configuration may update or modify a transmit power of the SSB.

As further shown in FIG. 16, in some aspects, the process 1600 may include transmitting the SSB in accordance with the transmit power (block 1620). For example, the network node (such as by using communication manager 150 or transmission component 1704, depicted in FIG. 17) may output (e.g., transmit or provide for transmission)the SSB in accordance with the transmit power.

The process 1600 may include additional aspects, such as any single aspect or any combination of aspects described in connection with the process 1600 or in connection with one or more other processes described elsewhere herein.

In a first additional aspect, the process 1600 includes receiving the STC from a central unit.

In a second additional aspect, alone or in combination with the first aspect, transmitting the configuration further includes transmitting the STC to a central unit.

In a third additional aspect, alone or in combination with one or more of the first and second aspects, the SMTC indicates transmit powers per cell or per group of cells.

In a fourth additional aspect, alone or in combination with one or more of the first through third aspects, transmitting the configuration further includes transmitting the SMTC via a system information block.

In a fifth additional aspect, alone or in combination with one or more of the first through fourth aspects, the SSB is associated with inter-node discovery.

Although FIG. 16 shows example blocks of the process 1600, in some aspects, the process 1600 may include additional blocks, fewer blocks, different blocks, or differently arranged blocks than those depicted in FIG. 16. Additionally, or alternatively, two or more of the blocks of the process 1600 may be performed in parallel.

FIG. 17 is a diagram of an example apparatus 1700 for wireless communication. The apparatus 1700 may be a network node, or a network node may include the apparatus 1700. In some aspects, the apparatus 1700 includes a reception component 1702 and a transmission component 1704, which may be in communication with one another (for example, via one or more buses or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 150. The communication manager 150 may include a configuration component 1708, among other examples.

In some aspects, the apparatus 1700 may be configured to perform one or more operations described herein in connection with FIGS. 3 through 11. Additionally, or alternatively, the apparatus 1700 may be configured to perform one or more processes described herein, such as the process 1200 of FIG. 12, the process 1300 of FIG. 13, the process 1600 of FIG. 16, or a combination thereof. In some aspects, the apparatus 1700 or one or more components shown in FIG. 17 may include one or more components of the network node described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network node described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network node described in connection with FIG. 2. In some aspects, the transmission component 1704 may be co-located with the reception component 1702 in a transceiver.

The transmission component 1704 or the configuration component 1708 may transmit a configuration that indicates a first transmit power associated with a first transmission of a downlink reference signal and a second transmit power associated with a second transmission of the downlink reference signal, where the first transmit power is different than the second transmit power. The transmission component 1704 may transmit the first transmission of the downlink reference signal in accordance with the first transmit power. The transmission component 1704 may transmit the second transmission of the downlink reference signal in accordance with the second transmit power.

The reception component 1702 may receive the STC from a central unit.

The transmission component 1704 may transmit the STC to a central unit.

The transmission component 1704 or the configuration component 1708 may transmit a configuration that indicates a first transmit power associated with a first PDSCH and a second transmit power associated with a second PDSCH, where the first transmit power is different than the second transmit power. The transmission component 1704 may transmit the first PDSCH in accordance with the first transmit power. The transmission component 1704 may transmit the second PDSCH in accordance with the second transmit power.

The transmission component 1704 or the configuration component 1708 may transmit, in a STC or an SMTC, a configuration that indicates a transmit power for an SSB. The transmission component 1704 may transmit the SSB in accordance with the transmit power.

The reception component 1702 may receive the STC from a central unit.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication. The apparatus 1800 may be a wireless communication device, or a wireless communication device may include the apparatus 1800. In some aspects, the apparatus 1800 includes a reception component 1802 and a transmission component 1804, which may be in communication with one another (for example, via one or more buses or one or more other components). As shown, the apparatus 1800 may communicate with another apparatus 1806 (such as a UE, a base station, or another wireless communication device) using the reception component 1802 and the transmission component 1804. As further shown, the apparatus 1800 may include the communication manager 140. The communication manager 140 may include a measurement component 1808, among other examples.

In some aspects, the apparatus 1800 may be configured to perform one or more operations described herein in connection with FIGS. 3 through 11. Additionally, or alternatively, the apparatus 1800 may be configured to perform one or more processes described herein, such as the process 1400 of FIG. 14, the process 1500 of FIG. 15, or a combination thereof. In some aspects, the apparatus 1800 or one or more components shown in FIG. 18 may include one or more components of the wireless communication device described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the wireless communication device described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the wireless communication device described in connection with FIG. 2. In some aspects, the transmission component 1804 may be co-located with the reception component 1802 in a transceiver.

The reception component 1802 may receive a configuration that indicates a first transmit power associated with a first transmission of a downlink reference signal and a second transmit power associated with a second transmission of the downlink reference signal, where the first transmit power is different than the second transmit power. The reception component 1802 or the measurement component 1808 may receive the first transmission of the downlink reference signal in accordance with the first transmit power. The reception component 1802 or the measurement component 1808 may receive the second transmission of the downlink reference signal in accordance with the second transmit power.

The reception component 1802 may receive a configuration that indicates a first transmit power associated with a first PDSCH and a second transmit power associated with a second PDSCH, where the first transmit power is different than the second transmit power. The reception component 1802 may receive the first PDSCH in accordance with the first transmit power. The reception component 1802 may receive the second PDSCH in accordance with the second transmit power.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

The foregoing disclosure provides illustration and description but is not intended to be exhaustive or to limit the aspects to the precise forms disclosed. Modifications and variations may be made in light of the disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a + b, a + c, b + c, and a + b + c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. An apparatus of a distributed unit (DU) for wireless communication, comprising:
one or more interfaces configured to:
output a configuration that indicates a first transmit power associated with a first transmission of a downlink reference signal and a second transmit power associated with a second transmission of the downlink reference signal, wherein the first transmit power is different than the second transmit power;
output the first transmission of the downlink reference signal in accordance with the first transmit power; and
output the second transmission of the downlink reference signal in accordance with the second transmit power.

2. The apparatus of claim 1, wherein the first transmission and the second transmission are transmissions of a synchronization signal block (SSB) burst set including the downlink reference signal.

3-4. (canceled)

5. The apparatus of claim 1, wherein the first transmit power is associated with the first transmission based at least in part on at least one of:
a bitmap,
an offset,
a periodicity,
a center frequency associated with the first transmission of the downlink reference signal, or
a multiplexing mode associated with the first transmission.

6. The apparatus of claim 1, wherein the configuration is included in a synchronization signal block (SSB) measurement timing configuration (SMTC) for a cell or group of cells associated with the downlink reference signal.

7-9. (canceled)

10. The apparatus of claim 1, wherein outputting the first transmission or outputting the second transmission is based at least in part on at least one of:
a configured timeline for applying the configuration, or
a timeline, indicated by the configuration, for applying the configuration.

11. The apparatus of claim 1, wherein the configuration includes a first synchronization signal block (SSB) measurement timing configuration (SMTC) that indicates the first transmit power and a second SMTC that indicates the second transmit power.

12. The apparatus of claim 1, wherein the configuration is included in a synchronization signal block (SSB) transmission configuration (STC).

13-14. (canceled)

15. The apparatus of claim 1, wherein the configuration indicates a scaling factor for measurements associated with the downlink reference signal.

16. The apparatus of claim 1, wherein the configuration indicates a reference transmit power.

17. The apparatus of claim 1, wherein the configuration indicates an offset between a transmit power of a physical broadcast channel (PBCH) of the downlink reference signal and a transmit power of a synchronization signal of the downlink reference signal.

18. The apparatus of claim 1, wherein the configuration indicates an offset between a transmit power of a primary synchronization signal (PSS) of the downlink reference signal and a transmit power of a secondary synchronization signal (SSS) of the downlink reference signal.

19. (canceled)

20. The apparatus of claim 1, wherein the first transmit power is associated with a first multiplexing mode of the first transmission and the second transmit power is associated with a second multiplexing mode of the second transmission.

21. The apparatus of claim 1, wherein the first transmit power is associated with a first resource type and the second transmit power is associated with a second resource type.

22. The apparatus of claim 1, wherein the configuration indicates the first transmit power or the second transmit power as a power control offset parameter of a channel state information reference signal configuration, and wherein a remainder of the channel state information reference signal configuration is unmodified by the configuration.

23. (canceled)

24. An apparatus of a distributed unit (DU) for wireless communication, comprising:
one or more interfaces configured to:
output a configuration that indicates a first transmit power associated with a first physical downlink shared channel (PDSCH) and a second transmit power associated with a second PDSCH, wherein the first transmit power is different than the second transmit power;
output the first PDSCH in accordance with the first transmit power; and
output the second PDSCH in accordance with the second transmit power.

25. The apparatus of claim 24, wherein the configuration indicates the first transmit power or the second transmit power based at least in part on a power control offset parameter of a channel state information reference signal (CSI-RS) configuration, wherein the power control offset parameter is between a CSI-RS and a synchronization signal or between a CSI-RS and a PDSCH.

26-27. (canceled)

28. The apparatus of claim 24, wherein the first transmit power is associated with a first power control offset parameter of a channel state information reference signal (CSI-RS) configuration and the second transmit power is associated with a second power control offset parameter of the CSI-RS configuration.

29-31. (canceled)

32. The apparatus of claim 24, wherein the configuration is a downlink bandwidth part configuration.

33. An apparatus of a wireless communication device, comprising:
one or more interfaces configured to:
obtain a configuration that indicates a first transmit power associated with a first transmission of a downlink reference signal and a second transmit power associated with a second transmission of the downlink reference signal, wherein the first transmit power is different than the second transmit power;
obtain the first transmission of the downlink reference signal in accordance with the first transmit power; and
obtain the second transmission of the downlink reference signal in accordance with the second transmit power.

34. The apparatus of claim 33, wherein the first transmission and the second transmission are transmissions of a synchronization signal block (SSB) burst set including the downlink reference signal.

35. The apparatus of claim 33, wherein the first transmission and the second transmission are associated with a periodic configuration, and wherein the first transmit power is for a first subset of transmission occasions of the periodic configuration and the second transmit power is for a second subset of transmission occasions of the periodic configuration.

36-38. (canceled)

39. The apparatus of claim 33, wherein the one or more interfaces, to obtain the first transmission or obtain the second transmission, are configured to obtain the first transmission or the second transmission based at least in part on at least one of:
a configured timeline for applying the configuration, or
a timeline, indicated by the configuration, for applying the configuration.

40. The apparatus of claim 33, wherein the configuration includes a first synchronization signal block (SSB) measurement timing configuration (SMTC) that indicates the first transmit power and a second SMTC that indicates the second transmit power.

41. The apparatus of claim 33, wherein the configuration is via system information, and wherein the apparatus further comprises a processing system configured to perform a radio resource management (RRM) measurement on the downlink reference signal, wherein the one or more interfaces are configured to output reporting information or triggering information based at least in part on the RRM measurement in accordance with the configuration.

42. The apparatus of claim 33, wherein the configuration indicates a scaling factor for measurements associated with the downlink reference signal, and wherein the apparatus further comprises a processing system configured to perform a measurement of the downlink reference signal using the scaling factor.

43. (canceled)

44. The apparatus of claim 33, wherein the configuration indicates an offset between a transmit power of a physical broadcast channel (PBCH) of the downlink reference signal and a transmit power of a synchronization signal of the downlink reference signal.

45. The apparatus of claim 33, wherein the configuration indicates an offset between a transmit power of a primary synchronization signal (PSS) of the downlink reference signal and a transmit power of a secondary synchronization signal (SSS) of the downlink reference signal.

46. The apparatus of claim 33, wherein the configuration indicates the first transmit power or the second transmit power as a power control offset parameter of a channel state information reference signal configuration, and wherein a remainder of the channel state information reference signal configuration is unmodified by the configuration.

47. (canceled)

48. An apparatus of a wireless communication device, comprising:
one or more interfaces configured to:
obtain a configuration that indicates a first transmit power associated with a first physical downlink shared channel (PDSCH) and a second transmit power associated with a second PDSCH, wherein the first transmit power is different than the second transmit power;
obtain the first PDSCH in accordance with the first transmit power; and
obtain the second PDSCH in accordance with the second transmit power.

49. The apparatus of claim 48, wherein the configuration indicates the first transmit power or the second transmit power based at least in part on updating a power control offset parameter of a channel state information reference signal (CSI-RS) configuration, wherein the power control offset parameter is between a CSI-RS and a synchronization signal or between a CSI-RS and a PDSCH.

50-220. (canceled)
